(19) United States
(12) Patent Application Publication
(10) Pub. No.: US 2024/0187128 A1
(43) Pub. Date: Jun. 6, 2024

(54) INDICATION OF PROPOSED CHANNEL STATE INFORMATION REPORTING SCHEME

(71) Applicant: Telefonaktiebolaget LM Ericsson (publ), Stockholm (SE)

(72) Inventors: Jonas FRÖBERG OLSSON, Ljungsbro (SE); Alexey SHAPIN, Luleå (SE); Niklas ANDGART, Södra Sandby (SE); Yufei BLANKENSHIP, Kildeer, IL (US)

(21) Appl. No.: 18/549,435

(22) PCT Filed: Mar. 10, 2022
(86) PCT No.: PCT/SE2022/050232

§ 371 Date: Sep. 7, 2023

Related U.S. Application Data
(60) Provisional application No. 63/159,968, filed on Mar. 11, 2021.

(51) Int. Cl. H04L 1/00; H04B 7/06

(52) U.S. Cl. CPC H04L 1/0026; H04B 7/0626; H04L 1/005

(57) ABSTRACT

A communication device, in a communications network that includes a network node, can obtain a plurality of channel state information (“CSI”) reporting configurations. The communication device can further determine a link quality measurement using CSI resources associated with the plurality of CSI reporting configurations. Responsive to determining the link quality measurement, the communication device can determine a CSI reporting configuration to be used in communicating CSI with the network node from the plurality of CSI reporting configurations based on the link quality measurement. Responsive to determining the CSI reporting configuration, the communication device can transmit information associated with the CSI reporting configuration to the network node.

### TECHNICAL FIELD

The present disclosure relates generally to communications, and more particularly to communication methods and related devices and nodes.

### BACKGROUND

FIG. 1 illustrates an example of a 5th Generation (“5G”) network (also referred to as a new radio (“NR”) network) including a pair of network nodes 110a-b (e.g., 5G base stations (“gNB”)) and multiple communication devices 120 (also referred to as user equipment (“UE”)).

### SUMMARY

According to some embodiments, a method of operating a communication device in a communications network that includes a network node is provided. The method includes obtaining a plurality of channel state information, CSI, reporting configurations. The method further includes determining a link quality measurement using CSI resources associated with the plurality of CSI reporting configurations. The method further includes, responsive to determining the link quality measurement, determining a CSI reporting configuration to be used in communicating CSI with the network node from the plurality of CSI reporting configurations based on the link quality measurement. The method further includes, responsive to determining the CSI reporting configuration, transmitting information associated with the CSI reporting configuration to the network node.

According to other embodiments, a method of operating a communication device in a communications network that includes a network node is provided. The method includes transmitting a first message to the network node, the first message indicating that the communication device is capable of determining the CSI reporting configuration. The method further includes receiving a second message from the network node, the second message instructing the communication device to handle determination of the CSI reporting configuration from the plurality of CSI configurations.

According to other embodiments, a method of operating a network node in a communications network is provided. The method includes transmitting a plurality of channel state information, CSI, reporting configurations to a communication device. The method further includes receiving information associated with a CSI reporting configuration of the plurality of CSI reporting configurations from the communication device.

According to other embodiments, a method of operating a network node in a communications network is provided. The method includes receiving a first message from a communication device, the first message indicating that the communication device is capable of determining the CSI reporting configuration. The method further includes transmitting a second message to the communication device, the second message instructing the communication device to handle determination of the CSI reporting configuration from the plurality of CSI configurations.

According to other embodiments, a communication device, network node, computer program, and a computer program product can be provided for performing the above methods.

Various embodiments described herein allow a UE to quickly and adequately report CSI to the network while limiting the amount of system resources used. Therefore, the use of uplink resources for CSI reporting can be reduced.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a wireless communications network;

FIG. 2 is a time-frequency grid illustrating an example of a NR physical resource with a resource block in a 14-symbol slot;

FIG. 3 is a diagram illustrating an example of a 14-symbol slot where the first symbols contain control channel and the rest contains data channel;

FIG. 4 is a diagram illustrating an example of a NZP CSI-RS resource configuration with 4 CSI-RS ports in a PRM in one slot;

FIG. 5 is a diagram illustrating an example of aperiodic CSI reporting based on an aperiodic NZP CSI-RS resource for channel measurement and a CSI-IM resource for interference measurement;

FIG. 6 is a diagram illustrating an example of aperiodic CSI reporting based on a periodic or semi-persistent NZP CSI-RS resource and a periodic or semi-persistent CSI-IM resource;

FIG. 7 is a diagram illustrating an example of a RRC IE with a CSI-ReportConfigList according to some embodiments of inventive concepts;

FIG. 8 is a diagram illustrating an example of a csi-ResourceConfigToReleaseList according to some embodiments of inventive concepts;

FIG. 9 is a table illustrating an example of a mapping for n=2 bit HARQ-ACK feedback that provides CSI in addition to ACK/NACK according to some embodiments of inventive concepts;

FIG. 10 is a table illustrating an example of CSI instance indicators according to some embodiments of inventive concepts;

FIG. 11 is a diagram illustrating an example of a CSI-MeasConfig extended to include aperiodicTriggerStateList-UE, SemiPersistentOnPUSCH-TriggerStateList-UE, and reportTriggerSize-UE according to some embodiments of inventive concepts;

FIG. 12 is a flow chart of operations performed by a UE according to some embodiments of inventive concepts;

FIG. 13 is a flow chart illustrating examples of operations of a UE according to some embodiments of inventive concepts;

FIG. 14 is a flow chart illustrating examples of operations of a network node according to some embodiments of inventive concepts.

FIG. 15 is a block diagram of a wireless network in accordance with some embodiments;

FIG. 16 is a block diagram of a user equipment in accordance with some embodiments

FIG. 17 is a block diagram of a virtualization environment in accordance with some embodiments;

FIG. 18 is a block diagram of a telecommunication network connected via an intermediate network to a host computer in accordance with some embodiments;

FIG. 19 is a block diagram of a host computer communicating via a base station with a user equipment over a partially wireless connection in accordance with some embodiments;

FIG. 20 is a block diagram of methods implemented in a communication system including a host computer, a base station and a user equipment in accordance with some embodiments;

FIG. 21 is a block diagram of methods implemented in a communication system including a host computer, a base station and a user equipment in accordance with some embodiments;

FIG. 22 is a block diagram of methods implemented in a communication system including a host computer, a base station and a user equipment in accordance with some embodiments; and

FIG. 23 is a block diagram of methods implemented in a communication system including a host computer, a base station and a user equipment in accordance with some embodiments.

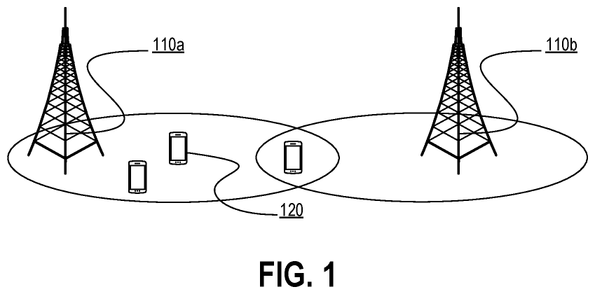

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

The next generation mobile wireless communication system (e.g., 5^{th} generation (“5G”) or new radio (“NR”)), will support a diverse set of use cases and a diverse set of deployment scenarios. The later includes deployment at both low frequencies (e.g., 100s of MHZ), similar to long term evolution (“LTE”) today, and very high frequencies (e.g., mm waves in the tens of GHZ).

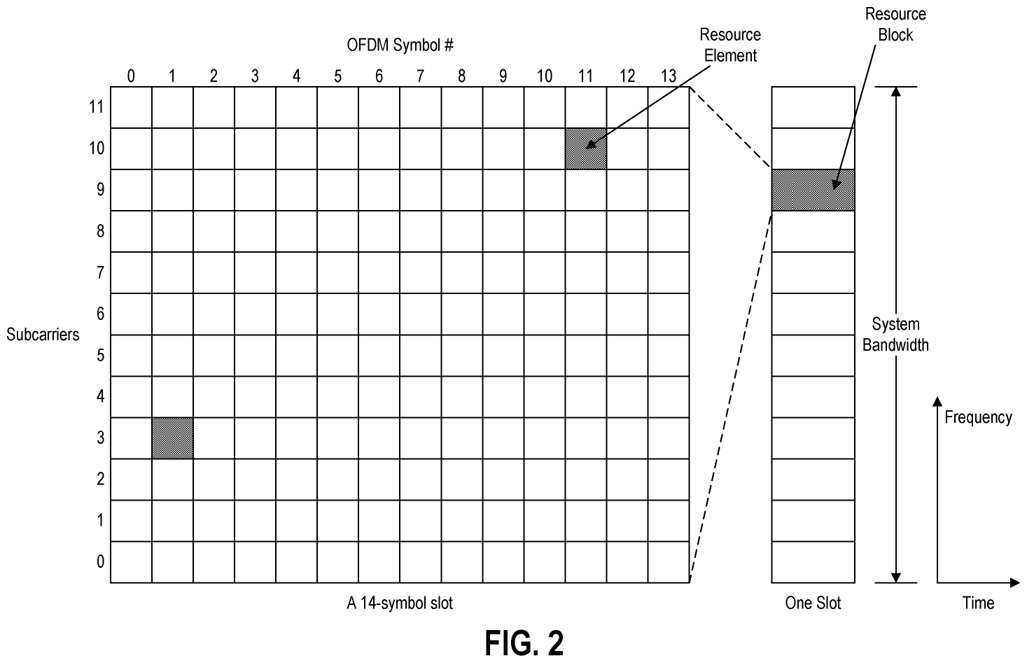

Similar to LTE, NR may use Orthogonal Frequency Division Multiplexing (“OFDM”) in the downlink (e.g., from a network node, gNB, eNB, or base station, to a user equipment (“UE”)). In the uplink, (e.g., from UE to gNB), both OFDM and Discrete Fourier Transformation (“DFT”)-spread OFDM (DFT-S-OFDM), also known as single-carrier frequency-division multiple access (“SC-FDMA”) in LTE, will be supported. The basic NR physical resource can thus be seen as a time-frequency grid as illustrated in FIG. 2, where a resource block (“RB”) in a 14-symbol slot is shown. In this example, a resource block corresponds to 12 contiguous subcarriers in the frequency domain. The RBs are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2^{μ}) kHz where μ is a non-negative integer and can be one of {0,1,2,3,4}. Δf=15 kHz (e.g., μ=0) is the basic (or reference) subcarrier spacing that is also used in LTE. μ is also referred to as the numerology.

In the time domain, downlink and uplink transmissions in NR can be organized into equally-sized subframes of 1 ms each similar to LTE. A subframe is further divided into multiple slots of equal duration. The slot length is dependent on the subcarrier spacing or numerology and is given by

$$\frac{1}{{2}^{μ}} ms .$$

Each slot includes 14 OFDM symbols for normal Cyclic Prefix (“CP”).

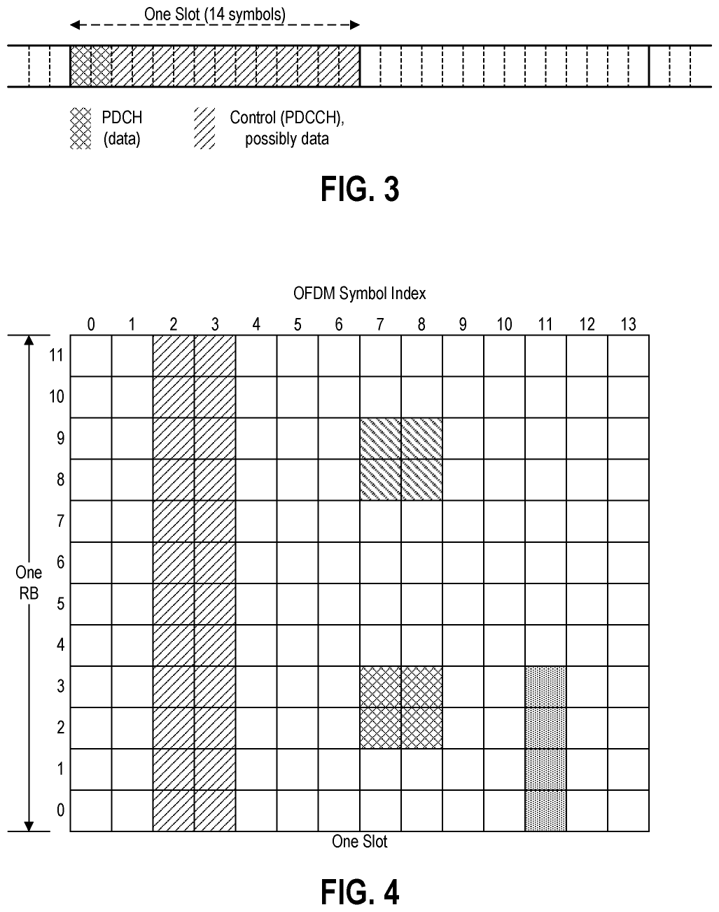

In some examples, data scheduling in NR can be in a slot basis. FIG. 3 illustrates an example of a 14-symbol slot, where the first two symbols contain control channel (e.g., physical downlink control channel (“PDCCH”)) and the rest contains data channel (e.g., physical downlink shared channel (“PDSCH”)).

Downlink transmissions can be dynamically scheduled, for example, in each slot the gNB transmits downlink control information (“DCI”) about which UE data is to be transmitted to and which resource blocks in the current downlink slot the data is transmitted on. This control signaling can be transmitted in the first one or two OFDM symbols in each slot in NR. The control information is carried on PDCCH and data is carried on PDSCH. A UE can first detect and decode PDCCH and if a PDCCH is decoded successfully, the UE can decode the corresponding PDSCH based on the decoded control information in the PDCCH.

Uplink data transmission can also be dynamically scheduled using PDCCH. Similar to downlink, a UE can decode uplink grants in PDCCH and then transmits data over the PUSCH based on the decoded control information in the uplink grant such as modulation order, coding rate, and uplink resource allocation.

Channel State Information (“CSI”) and CSI feedback is further described below. A core component in LTE and NR is the support of multiple input multiple output (“MIMO”) antenna deployments and MIMO related techniques. Spatial multiplexing is one of the MIMO techniques used to achieve high data rates in favorable channel conditions.

For an antenna array with N_{T} antenna ports at the gNB for transmitting r downlink (“DL”) symbols s=[s₁, s₂, . . . , sᵣ]^{T}, the received signal at a UE with N_{R} receive antennas at a certain resource element (“RE”) n can be expressed as

yₙ=HₙWs+eₙ,

where yₙ is a N_{R}×1 received signal vector; Hₙ a N_{R}×N_{T} channel matrix at the RE between the gNB and the UE; and W is an N_{T}×r precoder matrix; eₙ is a N_{R}×1 noise plus interference vector received at the RE by the UE. The precoder W can be a wideband precoder (e.g., constant over a whole bandwidth part (“BWP”)) or a subband precoder (e.g., constant over each subband).

The precoder matrix is typically selected from a codebook of possible precoder matrices, and typically indicated by means of a precoder matrix indicator (“PMI”), which specifies a unique precoder matrix in the codebook for a given number of symbol streams. The r symbols in s each corresponds to a spatial layer and r is referred to as the transmission rank.

The transmission rank is also dependent on the Signal to Noise Plus Interference Ratio (“SINR”) observed at the UE. Typically, a higher SINR is required for transmissions with higher ranks. For efficient performance, it is important that a transmission rank that matches the channel properties as well as the interference observed at a UE. For a given block error rate, the modulation level and coding scheme (“MCS”) is determined by the SINR, or channel quality. The precoding matrix, the transmission rank, and the channel quality are part of channel state information (“CSI”), which is typically measured by a UE and fed back to a network node or gNB.

Like in LTE, NR has adopted an implicit CSI mechanism where a UE feeds back the downlink CSI as one or more of a transmission rank indicator (“RI”), a PMI, and one or two channel quality indicator(s) (“CQI”). NR supports transmission of either one or two transport blocks (“TBs”) to a UE in a slot, depending on the rank. One TB is used for ranks 1 to 4, and two TBs are used for ranks 5 to 8. A CQI is associated to each TB. The CQI/RI/PMI report can be either wideband or subband based on configuration.

Channel State Information Reference Signal (“CSI-RS”) and Channel State Information Interference Measurement (“CSI-IM”) are further described below. Similar to LTE, CSI-RS was introduced in NR for channel estimations in the downlink. A CSI-RS is transmitted on each transmit antenna port and is used by a UE to measure downlink channel associated with each of antenna ports. Up to 32 CSI reference signals are defined. The antenna ports are also referred to as CSI-RS ports. The supported number of antenna ports in NR are {1,2,4,8,12,16,24,32}. By measuring the received CSI-RS, a UE can estimate the channel the CSI-RS is traversing, including the radio propagation channel and antenna gains. CSI-RS for this purpose is also referred to as Non-Zero Power (“NZP”) CSI-RS.

NZP CSI-RS can be configured to be transmitted in certain REs per PRB. FIG. 4 shows an example of a NZP CSI-RS resource configuration (shaded with a diagonal from top left to bottom right) with 4 CSI-RS ports in a PRB in one slot.

In addition to NZP CSI-RS, Zero Power (“ZP”) CSI-RS was introduced in NR. The purpose is to indicate to a UE that the associated REs are muted at the gNB. If the ZP CSI-RS is allocated to be fully overlapping with NZP CSI-RS in an adjacent cell, it can be used to improve channel estimation by UEs in the adjacent cell since there is no interference created by this cell.

CSI resource for interference measurement, CSI-IM, is used in NR for a UE to measure noise and interference, typically from other cells. CSI-IM includes 4 REs in a slot. In NR, two different CSI-IM patterns are possible: the CSI-IM pattern can be either 4 consecutive REs in one OFDM symbol or two consecutive REs in both frequency and time domains. An example is shown in FIG. 4, a first CSI-IM option is illustrated by shading that includes diagonals in both directions and a second CSI-IM option is illustrated by shading that includes isometric dots. Typically, gNB does not transmit any signal in the CSI-IM resource so that what is observed in the resource is noise and interference from other cells. The PDSCH is illustrated by shading that includes a diagonal from bottom left to top right.

By measuring both the channel based on a NZP CSI-RS resource and interference based on a CSI-IM resource, a UE can estimate the CSI (e.g., RI, PMI, and CQI(s)).

CSI framework in NR is described further below. In NR, a UE can be configured with one or multiple CSI report configurations. Each CSI report configuration is associated with a BWP and contains all the necessary information required for a CSI report, including: a CSI resource configuration for channel measurement; a CSI-IM resource configuration for interference measurement; reporting type (e.g., aperiodic CSI (on PUSCH), periodic CSI (on PUCCH) or semi-persistent CSI (on PUCCH, and DCI activated on PUSCH)); report quantity specifying what to be reported, such as RI, PMI, CQI; codebook configuration such as type I or type II CSI; frequency domain configuration (e.g., subband vs. wideband CQI or PMI, and subband size); and CQI table to be used.

A UE can be configured with one or multiple CSI resource configurations for channel measurement and one or more CSI-IM resources for interference measurement. Each CSI resource configuration for channel measurement can include one or more NZP CSI-RS resource sets. For each NZP CSI-RS resource set, it can further include one or more NZP CSI-RS resources. A NZP CSI-RS resource can be periodic, semi-persistent, or aperiodic.

Similarly, each CSI-IM resource configuration for interference measurement can include one or more CSI-IM resource sets. For each CSI-IM resource set, it can further include one or more CSI-IM resources. A CSI-IM resource can be periodic, semi-persistent, or aperiodic.

Periodic CSI starts after it has been configured by RRC and is reported on PUCCH, the associated NZP CSI-RS resource(s) and CSI-IM resource(s) are also periodic.

For semi-persistent CSI, it can be either on PUCCH or PUSCH. Semi-persistent CSI on PUCCH is activated or deactivated by a MAC CE command. Semi-persistent CSI on PUSCH is activated or deactivated by DCI. The associated NZP CSI-RS resource(s) and CSI-IM resource(s) can be either periodic or semi-persistent.

For aperiodic CSI, it is reported on PUSCH and is activated by a CSI request bit field in DCI. The associated NZP CSI-RS resource(s) and CSI-IM resource(s) can be either periodic, semi-persistent, or aperiodic. The linkage between a code point of the CSI request field and a CSI report configuration is via an aperiodic CSI trigger state. A UE is configured by higher layer a list of aperiodic CSI trigger states, where each of the trigger states contains an associated CSI report configuration. The CSI request field is used to indicate one of the aperiodic CSI trigger states and thus, one CSI report configuration.

If there are more than one NZP CSI-RS resource set and/or more than one CSI-IM resource set are associated with a CSI report configuration, only one NZP CSI-RS resource set and one CSI-IM resource set are selected in the aperiodic CSI trigger state. Thus, each aperiodic CSI report is based on a single NZP CSI-RS resource set and a single CSI-IM resource set.

In most of the scenarios, a NZP CSI-RS resource set includes only one NZP CSI-RS resource and a CSI-IM resource set contains a single CSI-IM resource. In some multi-beam scenarios where gNB has multiple DL beams and wants to know the best beam plus the associated CSI for a UE, multiple NZP CSI-RS resources, each associated with a beam, may be configured in a NZP CSI-RS resource set. The UE would select one NZP CSI-RS resource associated with the best beam and report a CSI associated with NZP CSI-RS resource. A CRI (CSI-RS resource indicator) would be reported as part of the CSI. In this example, the same number of CSI-IM resources, each paired with a NZP CSI-RS resource need to be configured in the associated CSI-IM resource set. That is, when a UE reports a CRI value k, this corresponds to the (k+1)^{th} entry of the NZP CSI-RS resource set for channel measurement, and, if configured, the (k+1)^{th} entry of the CSI-IM resource set for interference measurement.

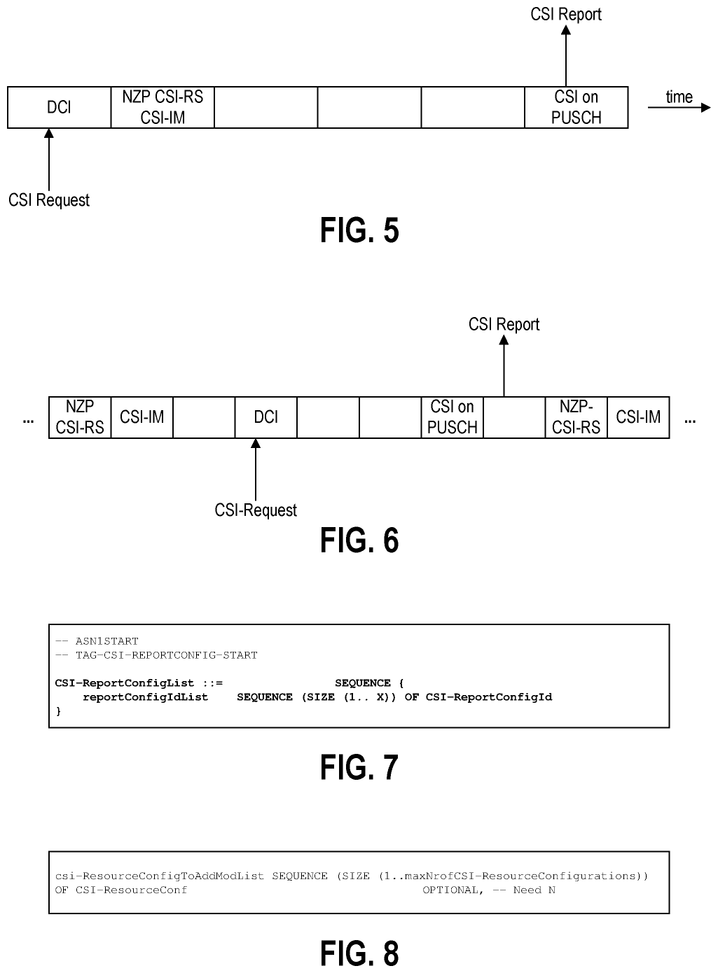

FIG. 5 shows an example of aperiodic CSI reporting based on an aperiodic NZP CSI-RS resource for channel measurement and a CSI-IM resource for interference measurement. The CSI is computed based on the aperiodic NZP-CSI-RS and CSI-IM triggered after the DCI. FIG. 6 is an example of aperiodic CSI reporting based on a periodic or semi-persistent NZP CSI-RS resource and a periodic or semi-persistent CSI-IM resource. In this case, the CSI is computed based on the channel and interference measurements done before the DCI triggering the CSI request.

The UE has the best possibilities of keeping track of the varying channel conditions, by measuring over various resources in time and frequency and thereby having up-to-date information. At the same time, the amount of CSI reporting that can be transmitted to the network is limited, in order not to occupy too much of system resources. Accordingly, the choice of when and what to report is done by the network, which then may not have the full picture.

Various embodiments described herein are based on an assumption that a communication device (e.g., a wireless device and/or UE) is able to (and configured to) measure link quality and further report one or more preferred ways report CSI. In some embodiments, the UE is capable of reporting one or more preferred CSI reporting instances among a pre-defined set of CSI reporting instances based on a measured link quality.

In some embodiments, a UE obtains a set of possible instances for CSI reporting (e.g., obtains a set of options for CSI reporting also referred to as possible CSI reporting schemes/configurations). The UE determines one or more link quality measures using the CSI resources linked to the set of CSI reporting configurations. The UE determines one or more CSI reporting configurations from the possible CSI reporting configurations based on the one or more link quality measures. The UE transmits an indicator that indicates the determined suggested instance(s) for CSI reporting.

In additional or alternative embodiments, the link quality measure is a measurement on reference signals (e.g. CSI-RS/CSI-IM/DMRS/PTRS/TRS/SSB). In additional or alternative embodiments, the link quality measure is based on decoder output. In additional or alternative embodiments, the transmission of the indicator is only implicitly indicated

In some embodiments, the UE can quickly and adequately report CSI to the network while limiting the amount of system resources. In additional or alternative embodiments, the use of uplink resources for CSI reporting can be reduced.

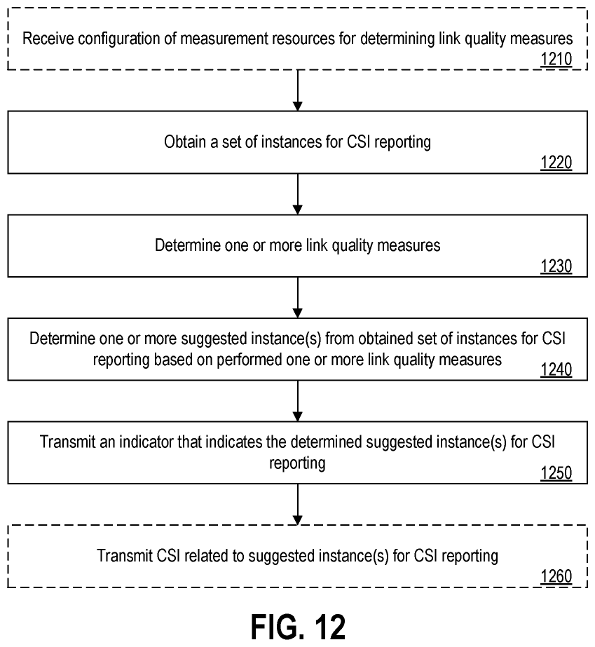

Various embodiments described herein assume that a communication device is able to (and configured to) measure link quality and further report CSI. In some embodiments, the communication device determines a preferred CSI reporting instance (e.g., a CSI reporting scheme or a CSI reporting configuration) based on the measured link quality. FIG. 12 is a flow chart illustrating an example of operations performed by the communication device according to some embodiments. At block 1210, the communication device can receive configuration of measurement resource for determining link quality measures. At block 1220, the communication device obtains a set of instances for CSI reporting (e.g., the UE obtains a set of CSI reporting schemes/configurations). At block 1230, the communication device determines one or more link quality measures using the CSI resources linked to the set of CSI reporting configurations. At block 1240, the communication device determines one or more suggested instance(s) from obtained set of instances for CSI reporting based on performed one or more link quality measures. At block 1250, the communication device transmits an indicator that indicates the determined suggested instance(s) for CSI reporting. At block 1260, the communication device transmits CSI related to suggested instance(s) for CSI reporting.

In some embodiments, the set of CSI reporting schemes/configurations is a set of CSI-ReportConfigld identifying a set of CSI report configurations.

In additional or alternative embodiments, the suggested instances may include CSI report configuration parameters such as CSI-RS and CSI-IM periodicities or recommended periodicities. In embodiments with a-periodic CSI-RS/IM the UE may recommend a target periodicity for scheduled CSI-RS/IM. The suggested instances may further include recommended configuration of pre-coder codebook, subband size for CSI, CQI table, or configuration parameters for UE filtering of channel and interference measurements.

In additional or alternative embodiments, the UE transmits CSI related to the suggested instance(s) autonomously (e.g., without the gNB having to trigger the UE to do so), the indicator indicating the determined suggested instances for CSI reported may be implicitly transmitted. For example, when there can be no confusion in gNB which scheme the CSI relates there is no need to explicitly transmit the indicator since the CSI itself carries the indicator implicitly. An example of such CSI reporting instance can be CSI on PUCCH or A-CSI on PUSCH reporting, which is based on CSI-RS or CSI-IM. Another example can be statistical CSI reporting with additional information such as mean, variance, min, max of interference. Yet another example of this can be CSI or Soft-HARQ information based on control or data signal reception and processing (such as channel estimation, demodulation and decoding). Other measurement and reporting schemes are not precluded by this list and some embodiments are intended to work with any measurement and reporting schemes.

In some embodiments, a communication device suggests one or more of the best suitable reporting schemes among multiple reporting schemes in hands for capturing radio link dynamics.

In additional or alternative embodiments, the communication device obtains a set of instances for CSI reporting (e.g., a set of reporting schemes). In some examples, the communication device obtains the set of instances for CSI reporting as part of an RRC message. In additional or alternative examples, the communication device obtains the set of instances from a standard or specification. In an RRC configured example, the communication device may be configured with a list, table, or similar structure in which each entry point to or indicate a CSI reporting instance. FIG. 7 illustrates and example of a RRC information element (“IE”) with a CSI-ReportConfigList that can be used to obtain the set of instances for CSI reporting.

In additional or alternative embodiments, a communication device can transmit a bit (or combination of bits) indicating which CSI reporting instance of the set of instances. For example, the communication device can transmit a ‘0’ indicating a 1^{st} instance of CSI reporting the first entry in CSI-ReportConfigList or a ‘1’ indicating a 2^{nd} instance the second entry in ReportConfigList. In an additional or alternative embodiment, the existing csi-ResourceConfigToReleaseList in CSI-MeasConfig can be used, as illustrated in FIG. 8. The integer indices 0, 1, . . . (X−1) can be used by the UE to point to the CSI reporting instances.

In some embodiments, the UE is configured with measurement resources, linked to each reportConfigID, for determining link quality measures on which the UE may determine link quality measures. For example, the UE may be configured with one or more CSI-RS and/or CSI-IM measurement resources on which UE can base determination of link quality measures. In another example, the UE may determine link quality measures based on PDSCH DMRS and/or PDSCH decoding.

In additional or alternative embodiments, the set of instances for CSI reporting includes a wide-band CSI reporting instance and a sub-band CSI reporting instance and the UE determines whether sub-band CSI reporting or wide-band CSI reporting is preferred.

In additional or alternative embodiments, the set of instances for CSI reporting includes a wide-band or sub-band CSI reporting instance and a statistical CSI reporting instance and the UE determines whether statistical CSI reporting is preferred. In some such embodiments, the UE may determine that statistical CSI reporting is preferred if a statistical measure a such as mean, standard-deviation, variance, percentile, min, max, median etc is above or below a threshold compared to a previous value b.

In additional or alternative embodiments, the set of instances for CSI reporting includes a CSI reporting in which the UE selects a sub-set of sub-bands as the reference resource for CSI. In such embodiments, the UE may determine whether or not such a CSI reporting is preferred.

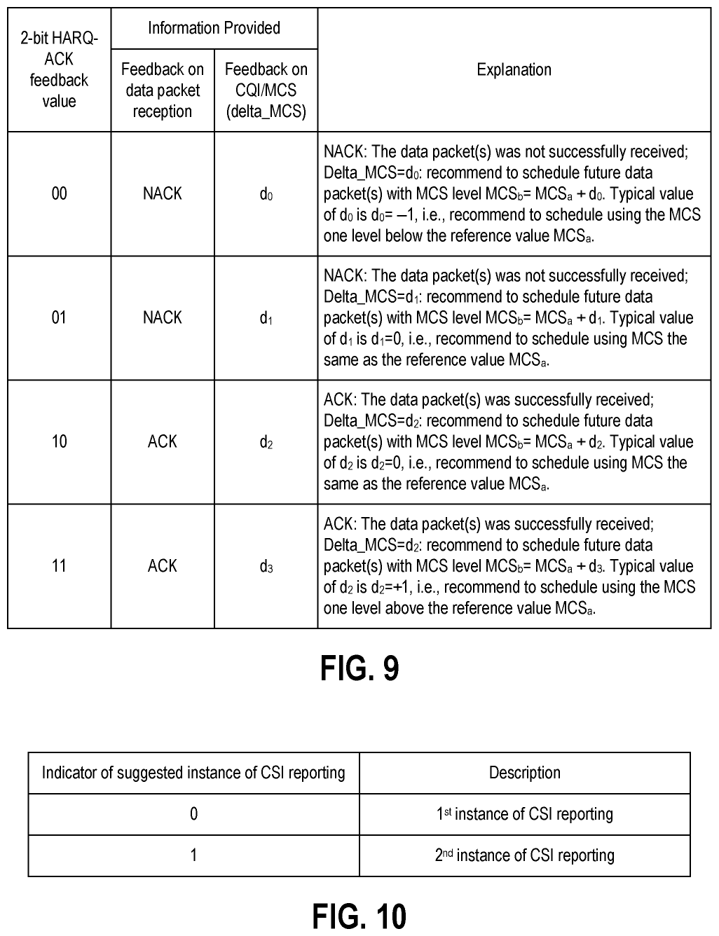

In additional or alternative embodiments, the set of instances for CSI reporting includes a Soft HARQ information. This can be a more fine-granular ACK/NACK report, such as indicating whether a successful decoding was achieved with high or low margin. A low margin can indicate to the network to employ a larger SNR backoff to increase robustness. An increased/decreased robustness may be indicated in a differential MCS, which could be sent by adding one more bits in the HARQ feedback (as illustrated in the table in FIG. 9). In FIGS. 9, d0, d1, d2, and d3 values may be different and non-integer (e.g., d2<0 enabling the UE to recommend to slightly decrease MCS if margin is low on recent ACK).

In some embodiments, the UE suggests the determined CSI configuration to the network. In other embodiments, the UE autonomously activates the determined CSI configuration on a need basis. This can be done in a way that if a certain scheme is not needed from the UE's point of view, then the UE will not use a reporting opportunity to send the report.

When a UE will activate or suggest a CSI is described further below. In this section, possible conditions to activate or suggest certain CSI reporting instance (scheme) are listed. In general, a CSI reporting instance trigger can be threshold based, periodic, in response to a request from gNB, or event based. For example, there may be a field in a downlink control information (“DCI”) indicating a request to the UE to send an indicator for one or more suggested instances for CSI reporting.

In some embodiments the UE is configured to transmit the indicator of one or more suggested instances CSI reporting when UE is configured with a new HARQ-ACK. When the new HARQ-ACK codebook is configured, one or more bits are included in UCI for transmission of the indicator.

In additional or alternative embodiments, a UE is configured or internally provided with threshold or multiple thresholds. If one or a set of thresholds are exceeded, the UE sends reporting suggestion signal or activate reporting instance. In some examples, if the UE measures a channel quality indicator (“CQI”), the threshold can be: expressed as a delta CQI compared to previous measurements; expressed as a difference between a worst sub-band CQI and a worst wide-band CQI; or expressed as a CQI variance over time and/or frequency. In additional or alternative examples, if the UE measures a decoding margin, the threshold can be: X number of iterations required to decode; metrics based on decoder statics, such as how many soft values have changed during decoding or between decoder iterations, or how bits have flipped during decoding or between decoder iterations; or an estimate by the block error probability, which can be obtained e.g., by studying the soft values. In additional or alternative examples, if the UE measures Rank, then the threshold can be the rank indicator (“RI”). In additional or alternative examples, if the UE measures a signal interference to noise ratio (“SINR”), the threshold can be in dB of equivalent. In additional or alternative examples, if the UE measures signal strength, the threshold can be in signal power. The UE can be configured to send suggestion signal periodically or activate CSI reporting instance periodically (e.g., every 50 ms or every 50 slots).

In additional or alternative embodiments, the UE can be (requested) ordered by gNB to send a suggestion signal or to activate a reporting scheme. The gNB can already activate CSI configurations by a bit field in DCI, but the delta is an extension of this activation mechanism to be able to: activate new reporting metrics such as CSI statistic, interference statistic, worst CQI, DMRS based CSI, and Soft-HARQ information; and request reporting scheme suggestion signal

In additional or alternative embodiments, the UE can have a set of event-based triggers either internally defined or configured by gNB. When an event or set of events happen, the UE can send a reporting suggestion signal or activate reporting instance(s). In some examples, triggering can be intentionally delayed. The events can include: a beam change; a precoder change; receiving scheduling command with Multi-TRP allocation; a RRC reconfiguration; a handover (“HO”) (e.g., a successful HO or a HO failure); a data decoding failure (HARQ-NACK); and timer based events (e.g., an inability to decode PDCCH/PDSCH for some time).

How to send suggested CSI instance indicator is further described below. In some embodiments, the suggested CSI instance indicator can be sent explicitly or implicitly.

In some examples, the CSI instance indicator can be sent explicitly, for example, piggybacked with HARQ feedback, one or more bits included in uplink control information (“UCI”), included in a media access control element (“MAC CE”), or included in configuration grant (“CG”) UCI. The indicator can be appended (or prepended) to HARQ-ACK bits for the HARQ-ACK codebook. The indicator can be transmitted periodically according to a configured periodicity. In additional or alternative examples, the suggested CSI instance indicator is transmitted as separate UCI on PUCCH (e.g., the indicator is associated with a PUCCH format).

In some examples, the indicator can also be implicit, for example, if the gNB determines the value of the indicator or determine to which instance CSI relates based on blind decoding of PUCCH. The implicit transmission of the indicator can follow similar rules as for scheduling request (“SR”) transmission. For example, a HARQ-ACK is transmitted on the PUCCH resource for the suggested CSI instance indicator when HARQ-ACK is present and the indicator indicates ‘0’ (or ‘1’) while HARQ-ACK is transmitted on PUCCH resource configured for HARQ-ACK if the indicator indicates ‘1’ (or ‘0’).

In additional or alternative examples, the indicator can also be implicit such that the resource the UE is using to send the CSI determines the type of CSI instance, and that several UEs may be configured to use the same transmission resources, sharing them in a contention-based approach. A contention-based approach is an option when the UEs most often do not transmit a certain CSI instance, but want to have the possibility to do it based on channel conditions.

In some embodiments, the UE is configured by RRC to perform the operations described herein for determining a CSI reporting configuration.

In some embodiments, the suggested CSI instance indicator may, for example, be defined according to the table in FIG. 10, where the 1^{st} and 2^{nd} instance of CSI reporting relate to first and second entry in a RRC configured table/list (e.g., in CSI-ReportConfigList defined earlier).

In some embodiments, the 1^{st} instance of CSI reporting could be a wideband CSI reporting instance while the 2^{nd} instance is a statistical CSI reporting instance. In additional or alternative embodiments, the 2^{nd} or 1^{st} instance may be a soft-HARQ-ACK CSI reporting. In additional or alternative embodiments, the indicator may be transmitted with more than one bit such that the UE can indicate one out more than two instances. In additional or alternative embodiments, the indicator can indicate sets of suggested instances of CSI reporting. For example, indicator value ‘0’ may indicate single instance {X} while a value ‘1’ may indicate the set {Y, Z} of the instances Y and Z.

In some embodiments, the UE is configured to autonomously activate reporting of CSI for suggested/preferred instance for CSI reporting. In additional or alternative embodiments, the UE reported the indicator of suggested instance of CSI reporting and only report CSI for the suggested instance for CSI reporting upon receiving a request (e.g., a CSI request) from gNB to do so.

In additional or alternative embodiments, the UE may suggest an instance of CSI reporting which may require a gNB to re-distribute or re-configure other UEs. In such embodiments, the UE is configured to only transmit CSI for suggested instance for CSI reporting when receiving a message (RRC, MAC CE, DCI) that configure the UE to transmit CSI for the suggested instance for CSI reporting.

In additional or alternative embodiments, the UE may suggest an instance of CSI reporting that require one or more measurements on reference signals (e.g. CSI-RS, DMRS, etc) before UE can report CSI for suggested CSI. In some such embodiments, the required reference signals have not been present to UE when UE transmits the indicator for the suggested one or more instance for CSI reporting. In such embodiments, gNB may have to provide those reference signals by RRC configuration or schedule the reference signals by one or more DCI until UE is capable to report CSI for suggested instance for CSI reporting. In some such embodiments, there may be new CSI processing time requirements that restricts when UE is capable to report CSI for suggested instance(s) for CSI reporting. For example, the new CSI processing time requirements may include restriction with regard to one or more of: time from last CSI-RS until report of CSI for suggested instance(s) for CSI reporting; time from last CSI-IM until report of CSI for suggested instance(s) for CSI reporting; number of occasions for measurement on CSI-RS; and number of occasions for measurement on CSI-IM.

In additional or alternative embodiments, the UE is configured with one or more CSI reporting instances having certain periodicity and all of them are considered to be active, but UE is allowed to skip reporting opportunity if CSI reporting instance in unpreferred/non-suggested by UE. On the contrary if triggering conditions are fulfilled, the UE will take a chance and transmit CSI reporting instance on allocated resources.

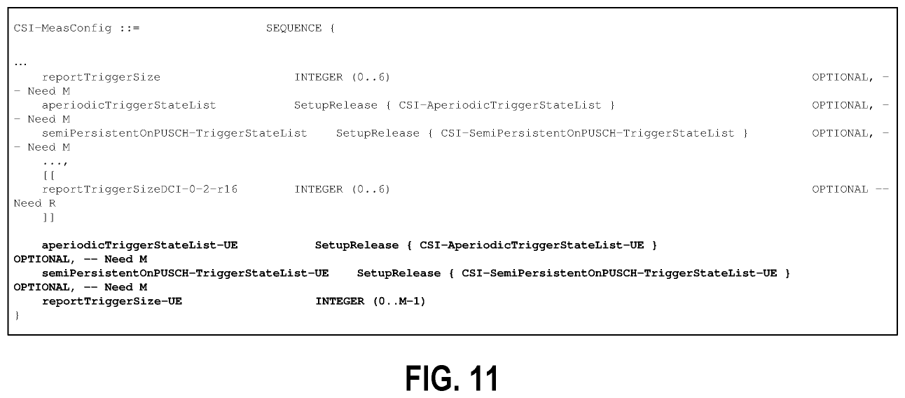

While some of the embodiments above described the operation of the UE selecting a CSI reporting instance before performing CSI reporting, another alternative is to define a trigger state list for the UE to select from. As an example, FIG. 11 illustrates that CSI-MeasConfig can be extended to include aperiodicTriggerStateList-UE, semiPersistentOnPUSCH-TriggerStateList-UE, reportTriggerSize-UE.

In some embodiments, the CSI-AperiodicTriggerStateList-UE is used to configure the UE with a list of aperiodic trigger states. Each codepoint in a UCI field “CSI selection” is associated with one trigger state. After UE reports the value (e.g., via UCI field “CSI selection”) associated with a trigger state, the UE will perform measurement of CSI-RS, CSI-IM and/or SSB (reference signals) and aperiodic reporting on L1 according to all entries in the associatedReportConfigInfoList for that trigger state.

In some examples, after receiving the UCI field “CSI selection” from the UE, the gNB can dynamically schedule a PUSCH to carry the aperiodic CSI.

In other examples, if the gNB is scheduled with one or more uplink configured grant (“CG”) configurations, then the aperiodic CSI report as selected by the UE can be carried by a UL CG PUSCH. The specific CG PUSCH can determined using one or more of: the CG configuration with a predefined, particular, configuration index, for example, the lowest index value, or the highest index value; the CG configuration signaled by the gNB, either via RRC signaling or MAC CE signaling; the CG configuration selected by the UE; and the CG configuration which has the earliest transmission opportunity. In regard to the CG configuration that has the earliest transmission opportunity, the earliest transmission opportunity can be defined as one or more of: the earliest after the corresponding UCI with “CSI selection” is sent; the earliest which is T_CSI_proc amount of time after the corresponding UCI with “CSI selection” is sent. T_CSI_proc can be defined to provide time for the UE to generate the CSI report; or the earliest after UE has received an acknowledgement, or permission, from the gNB to transmit the CSI report as selected by the UE.

The IE reportTriggerSize-UE can provide the bit width of the UCI field “CSI selection”. Preferably, the maximum size M is small, for example, M<=4.

In additional or alternative embodiments, as shown above, the UE may be additionally, or alternatively, provided with a semiPersistentOnPUSCH-TriggerStateList-UE, so that the UE may select from this list of trigger state to perform semi-persistent CSI reporting.

In some examples, each codepoint in a UCI field “CSI selection” is associated with one trigger state. In additional or alternative examples, after the UE reports the value (e.g., via UCI field “CSI selection”) associated with a trigger state, the UE will perform measurement of CSI-RS, CSI-IM and/or SSB (reference signals) and semi-persistent CSI reporting on L1 according to all entries in the associatedReportConfigInfo for that trigger state. In additional or alternative example, for carrying the semi-persistent CSI report, CG PUSCH with periodicity the same as that of semi-persistent CSI report is preferred. The CG configuration index can be obtained using at least one of: the CG configuration with a predefined configuration index, for example, the lowest index value, or the highest index value; the CG configuration signaled by the gNB, either via RRC signaling or MAC CE signaling; and the CG configuration selected by the UE.

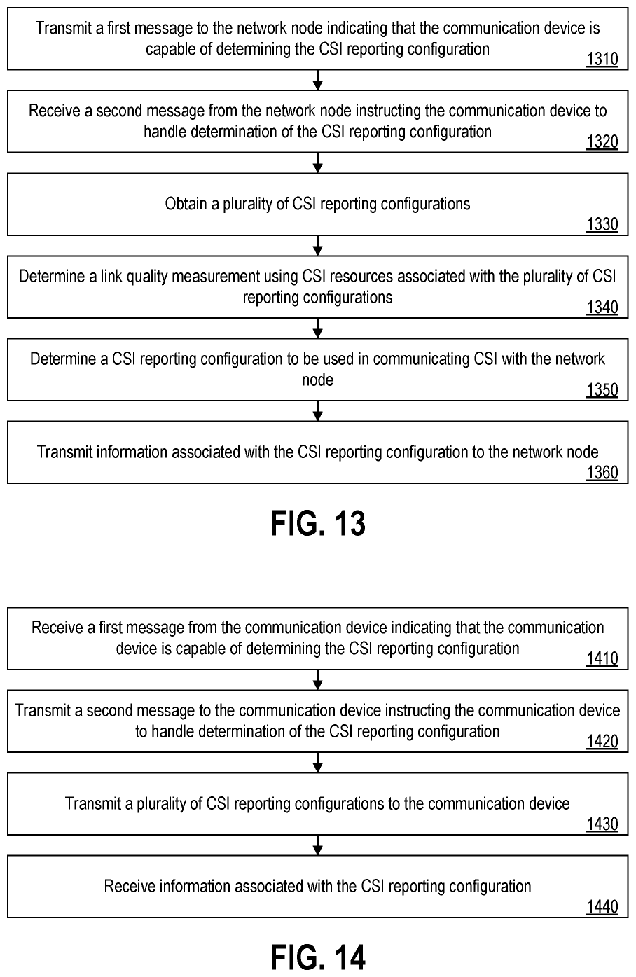

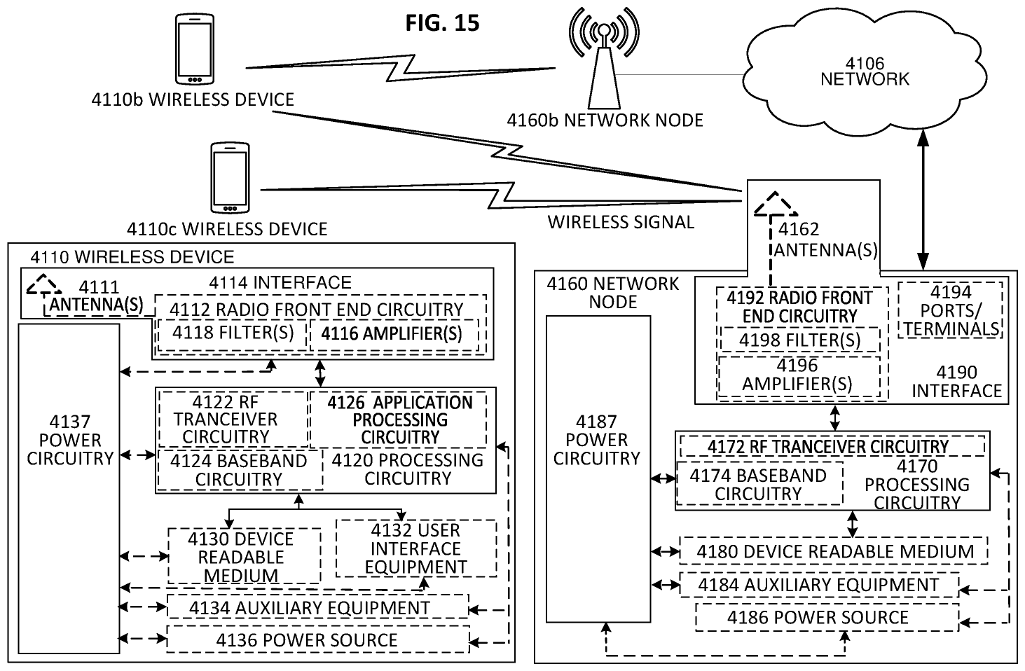

Operations of a communication device (implemented using the structure of the block diagram of FIG. 15 will now be discussed with reference to the flow chart of FIG. 13 according to some embodiments of inventive concepts. For example, modules may be stored in memory 4130 of FIG. 15, and these modules may provide instructions so that when the instructions of a module are executed by respective communication device processing circuitry 4120, processing circuitry 4120 performs respective operations of the flow chart.

At block 1310, processing circuitry 4120 transmits, via interface 4114, a first message to the network node indicating that the communication device is capable of determining the CSI reporting configuration.

At block 1320, processing circuitry 4120 receives, via interface 4114, a

second message from the network node instructing the communication device to handle determination of the CSI reporting configuration.

At block 1330, processing circuitry 4120 obtains a plurality of CSI reporting configurations. In some embodiments, the plurality of CSI reporting configurations includes at least one of: a wide-band CSI reporting configuration; a sub-band CSI reporting configuration; a statistical CSI reporting configuration; a hybrid automatic repeat request, HARQ, based CSI reporting configuration. In additional or alternative embodiments, obtaining the plurality of CSI reporting configurations includes receiving at least a portion of the plurality of CSI reporting configurations from the network node.

At block 1340, processing circuitry 4120 determines a link quality measurement using CSI resources associated with the plurality of CSI reporting configurations.

At block 1350, processing circuitry 4120 determines a CSI reporting configuration to be used in communicating CSI with the network node. In some embodiments, determining the link quality measurement includes measuring the link quality measurement associated with a reference signal including at least one of: a channel state information reference signal, CSI-RS; a channel state information interference measurement, CSI-IM; a demodulation reference signal, DMRS; a phase tracking reference signal, PTRS; a tracking reference signal, TRS; and a synchronization signal block, SSB. In additional or alternative embodiments, determining the link quality measurement includes determining the link quality measurement based on decoder output.

At block 1360, processing circuitry 4120 transmits, via a interface 4114, information associated with the CSI reporting configuration to the network node. In some embodiments, transmitting the information includes transmitting an indicator of the CSI reporting configuration to the network node.

In additional or alternative embodiments, transmitting the information includes transmitting a CSI report to the network node based on the CSI reporting configuration. In additional or alternative embodiments, transmitting the information further includes receiving a request from the network node for the CSI report; and transmitting the CSI report in response to receiving the request. In additional or alternative embodiments, transmitting the information further includes determining that the link quality measurement exceeds a threshold value; and transmitting the CSI report in response to determining that the link quality measurement exceeds the threshold value. In some examples, exceeding a threshold value includes going above the threshold value. In other examples, exceeding the threshold value includes going below the threshold value.

In additional or alternative embodiments, transmitting the information further includes detecting occurrence of an event; and transmitting the CSI report in response to detecting occurrence of the event. In additional or alternative embodiments, the event includes at least one of: a beam change; a precoder change; receiving a scheduling command with multi-transmission/reception point, TRP, allocation; radio resource control, RRC, reconfiguration; a handover, a data decoding failure; and a timer based event.

Various operations from the flow chart of FIG. 13 may be optional with respect to some embodiments of communication devices and related methods. In some examples, in regards to Example Embodiment 1, below, blocks 1310 and 1320 are optional. In other examples, in regards to Example Embodiment 14, below, blocks 1330, 1340, 1350, and 1360 are optional.

Operations of a network node (implemented using the structure of the block diagram of FIG. 15 will now be discussed with reference to the flow chart of FIG. 14 according to some embodiments of inventive concepts. For example, modules may be stored in memory 4180 of FIG. 15, and these modules may provide instructions so that when the instructions of a module are executed by respective communication device processing circuitry 4170, processing circuitry 4170 performs respective operations of the flow chart. Although FIG. 14 is described in regards to RAN node 4160 any network node (e.g., a CN) may perform the operations.

At block 1410, processing circuitry 4170 receives, via interface 4190, a first message from the communication device indicating that the communication device is capable of determining the CSI reporting configuration.

At block 1420, processing circuitry 4170 transmits, via interface 4190, a second message to the communication device instructing the communication device to handle determination of the CSI reporting configuration.

At block 1430, processing circuitry 4170 transmits, via interface 4190, a plurality of CSI reporting configurations to the communication device. In some embodiments, the plurality of CSI reporting configurations includes at least one of: a wide-band CSI reporting configuration; a sub-band CSI reporting configuration; a statistical CSI reporting configuration; a hybrid automatic repeat request, HARQ, based CSI reporting configuration.

At block 1440, processing circuitry 4170 receives, via interface 4190, information associated with the CSI reporting configuration. In some embodiments, receiving the information includes receiving an indicator of the CSI reporting configuration from the communication device. In additional or alternative embodiments, receiving the information includes receiving a CSI report from the communication device based on the CSI reporting configuration. In additional or alternative embodiments, receiving the information further includes transmitting a request for the CSI report to the communication device; and receiving the CSI report in response to transmitting the request.

Various operations from the flow chart of FIG. 14 may be optional with respect to some embodiments of communication devices and related methods. In some examples, in regards to Example Embodiment 16, below, blocks 1410 and 1420 are optional. In other examples, in regards to Example Embodiment 23, below, blocks 1430 and 1440 are optional.

Example embodiments are discussed below.

Embodiment 1. A method of operating a communication device in a communications network that includes a network node, the method comprising:
obtaining (1330) a plurality of channel state information, CSI, reporting configurations;
determining (1340) a link quality measurement using CSI resources associated with the plurality of CSI reporting configurations;
responsive to determining the link quality measurement, determining (1350) a CSI reporting configuration to be used in communicating CSI with the network node from the plurality of CSI reporting configurations based on the link quality measurement; and
responsive to determining the CSI reporting configuration, transmitting (1360) information associated with the CSI reporting configuration to the network node.

Embodiment 2. The method of Embodiment 1, wherein the plurality of CSI reporting configurations comprises at least one of: a wide-band CSI reporting configuration; a sub-band CSI reporting configuration; a statistical CSI reporting configuration; a hybrid automatic repeat request, HARQ, based CSI reporting configuration.

Embodiment 3. The method of any of Embodiments 1-2, wherein obtaining the plurality of CSI reporting configurations comprises:
receiving at least a portion of the plurality of CSI reporting configurations from the network node.

Embodiment 4. The method of any of Embodiments 1-3, wherein transmitting the information comprises:
transmitting an indicator of the CSI reporting configuration to the network node.

Embodiment 5. The method of any of Embodiments 1-4, wherein transmitting the information comprises:
transmitting a CSI report to the network node based on the CSI reporting configuration.

Embodiment 6. The method of Embodiment 5, wherein transmitting the information further comprises:
receiving a request from the network node for the CSI report; and transmitting the CSI report in response to receiving the request.

Embodiment 7. The method of any of Embodiment 5, wherein transmitting the information further comprises:
determining that the link quality measurement exceeds a threshold value; and
transmitting the CSI report in response to determining that the link quality measurement exceeds the threshold value.

Embodiment 8. The method of any of Embodiments 5-7, wherein transmitting the information further comprises:
detecting occurrence of an event; and
transmitting the CSI report in response to detecting occurrence of the event.

Embodiment 9. The method of Embodiment 8, the event comprising at least one of: a beam change; a precoder change; receiving a scheduling command with multi-transmission/reception point, TRP, allocation; radio resource control, RRC, reconfiguration; a handover, a data decoding failure; and a timer based event.

Embodiment 10. The method of any of Embodiments 1-9, wherein determining the link quality measurement comprises:
measuring the link quality measurement associated with a reference signal including at least one of: a channel state information reference signal, CSI-RS; a channel state information interference measurement, CSI-IM; a demodulation reference signal, DMRS; a phase tracking reference signal, PTRS; a tracking reference signal, TRS; and a synchronization signal block, SSB.

Embodiment 11. The method of any of Embodiments 1-10, wherein determining the link quality measurement comprises:
determining the link quality measurement based on decoder output.

Embodiment 12. The method of any of Embodiments 1-11, wherein the communications network is a new radio, NR, network, and
wherein the network node is a radio access network, RAN, node.

Embodiment 13. The method of any of Embodiments 1-12, further comprising:
transmitting (1310) a first message to the network node, the first message indicating that the communication device is capable of determining the CSI reporting configuration; and
receiving (1320) a second message from the network node, the second message instructing the communication device to handle determination of the CSI reporting configuration from the plurality of CSI configurations.

Embodiment 14. A method of operating a communication device in a communications network that includes a network node, the method comprising:
transmitting (1310) a first message to the network node, the first message indicating that the communication device is capable of determining the CSI reporting configuration; and
receiving (1320) a second message from the network node, the second message instructing the communication device to handle determination of the CSI reporting configuration from the plurality of CSI configurations.

Embodiment 15. The method of Embodiment 14, further comprising any operations of Embodiments 1-13.

Embodiment 16. A method of operating a network node in a communications network, the method comprising:
transmitting (1430) a plurality of channel state information, CSI, reporting configurations to a communication device; and receiving (1440) information associated with a CSI reporting configuration of the plurality of CSI reporting configurations from the communication device.

Embodiment 17. The method of Embodiment 16, wherein the plurality of CSI reporting configurations comprises at least one of: a wide-band CSI reporting configuration; a sub-band CSI reporting configuration; a statistical CSI reporting configuration; a hybrid automatic repeat request, HARQ, based CSI reporting configuration.

Embodiment 18. The method of any of Embodiments 16-17, wherein receiving the information comprises:
receiving an indicator of the CSI reporting configuration from the communication device.

Embodiment 19. The method of any of Embodiments 16-18, wherein receiving the information comprises:
receiving a CSI report from the communication device based on the CSI reporting configuration.

Embodiment 20. The method of Embodiment 19, wherein receiving the information further comprises:
transmitting a request for the CSI report to the communication device; and receiving the CSI report in response to transmitting the request.

Embodiment 21. The method of any of Embodiments 16-20, wherein the communications network is a new radio, NR, network, and
wherein the network node is a radio access network, RAN, node.

Embodiment 22. The method of any of Embodiments 16-21, further comprising:
receiving (1410) a first message from the communication device, the first message indicating that the communication device is capable of determining the CSI reporting configuration; and
transmitting (1420) a second message to the communication device, the second message instructing the communication device to handle determination of the CSI reporting configuration from the plurality of CSI configurations.

Embodiment 23. A method of operating a network node in a communications network, the method comprising:
receiving (1410) a first message from a communication device, the first message indicating that the communication device is capable of determining the CSI reporting configuration; and
transmitting (1420) a second message to the communication device, the second message instructing the communication device to handle determination of the CSI reporting configuration from the plurality of CSI configurations.

Embodiment 24. The method of Embodiment 23, further comprising any operations of Embodiments 16-22.

Embodiment 25. A communication device (4110) in a communications network that includes a network node, the communication device comprising:
processing circuitry (4120); and
memory (4130) coupled to the processing circuitry and having instructions stored therein that are executable by the processing circuitry to cause the communication device to perform operations comprising any of the operations of Embodiments 1-15.

Embodiment 26. A communication device (4110) in a communications network that includes a network node, the communication device adapted to perform any of the operations of Embodiments 1-15.

Embodiment 27. A computer program comprising program code to be executed by processing circuitry (4120) of a communication device (4110) in a communications network that includes a network node, whereby execution of the program code causes the communication device to perform operations comprising any of the operations of Embodiments 1-15.

Embodiment 28. A computer program product comprising a non-transitory storage medium including program code to be executed by processing circuitry (4120) of a communication device (4110) in a communications network that includes a network node, whereby execution of the program code causes the communication device to perform operations comprising any of the operations of Embodiments 1-15.

Embodiment 29. A network node (4160) in a communications
network, the network node comprising:
processing circuitry (4170); and memory (4180) coupled to the processing circuitry and having instructions stored therein that are executable by the processing circuitry to cause the network node to perform operations comprising any of the operations of Embodiments 16-24.

Embodiment 30. A network node (4160) in a communications network, the network node adapted to perform any of the operations of Embodiments 16-24.

Embodiment 31. A computer program comprising program code to be executed by processing circuitry (4170) of a network node (4160) in a communications network, whereby execution of the program code causes the communication device to perform operations comprising any of the operations of Embodiments 16-24.

Embodiment 32. A computer program product comprising a non-transitory storage medium including program code to be executed by processing circuitry (4170) of a network node (4160) in a communications network, whereby execution of the program code causes the network node to perform operations comprising any of the operations of Embodiments 16-24.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 15 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 15. For simplicity, the wireless network of FIG. 15 only depicts network 4106, network nodes 4160 and 4160b, and WDs 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 15, network node 4160 includes processing circuitry 4170, device readable medium 4180, interface 4190, auxiliary equipment 4184, power source 4186, power circuitry 4187, and antenna 4162. Although network node 4160 illustrated in the example wireless network of FIG. 15 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and a RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units

In certain embodiments, some or all of the functionality described herein as being provided by a network node, base station, eNB or other such network device may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner. In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4192 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHZ and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 4162 may be separate from network node 4160 and may be connectable to network node 4160 through an interface or port.

Antenna 4162, interface 4190, and/or processing circuitry 4170 may be configured to perform any receiving operations and/or certain obtaining operations described herein as being performed by a network node. Any information, data and/or signals may be received from a wireless device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a wireless device, another network node and/or any other network equipment.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 15 that may be responsible for providing certain aspects of the network node's functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (IOT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IOT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 4110 includes antenna 4111, interface 4114, processing circuitry 4120, device readable medium 4130, user interface equipment 4132, auxiliary equipment 4134, power source 4136 and power circuitry 4137. WD 4110 may include multiple sets of one or more of the illustrated components for different wireless technologies supported by WD 4110, such as, for example, GSM, WCDMA, LTE, NR, WiFi, WiMAX, or Bluetooth wireless technologies, just to mention a few. These wireless technologies may be integrated into the same or different chips or set of chips as other components within WD 4110.

Antenna 4111 may include one or more antennas or antenna arrays, configured to send and/or receive wireless signals, and is connected to interface 4114. In certain alternative embodiments, antenna 4111 may be separate from WD 4110 and be connectable to WD 4110 through an interface or port. Antenna 4111, interface 4114, and/or processing circuitry 4120 may be configured to perform any receiving or transmitting operations described herein as being performed by a WD. Any information, data and/or signals may be received from a network node and/or another WD. In some embodiments, radio front end circuitry and/or antenna 4111 may be considered an interface.

As illustrated, interface 4114 comprises radio front end circuitry 4112 and antenna 4111. Radio front end circuitry 4112 comprise one or more filters 4118 and amplifiers 4116. Radio front end circuitry 4112 is connected to antenna 4111 and processing circuitry 4120, and is configured to condition signals communicated between antenna 4111 and processing circuitry 4120. Radio front end circuitry 4112 may be coupled to or a part of antenna 4111. In some embodiments, WD 4110 may not include separate radio front end circuitry 4112; rather, processing circuitry 4120 may comprise radio front end circuitry and may be connected to antenna 4111. Similarly, in some embodiments, some or all of RF transceiver circuitry 4122 may be considered a part of interface 4114. Radio front end circuitry 4112 may receive digital data that is to be sent out to other network nodes or WDs via a wireless connection. Radio front end circuitry 4112 may convert the digital data into a radio signal having the appropriate channel and bandwidth parameters using a combination of filters 4118 and/or amplifiers 4116. The radio signal may then be transmitted via antenna 4111. Similarly, when receiving data, antenna 4111 may collect radio signals which are then converted into digital data by radio front end circuitry 4112. The digital data may be passed to processing circuitry 4120. In other embodiments, the interface may comprise different components and/or different combinations of components.

Processing circuitry 4120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4110 components, such as device readable medium 4130, WD 4110 functionality. Such functionality may include providing any of the various wireless features or benefits discussed herein. For example, processing circuitry 4120 may execute instructions stored in device readable medium 4130 or in memory within processing circuitry 4120 to provide the functionality disclosed herein.

As illustrated, processing circuitry 4120 includes one or more of RF transceiver circuitry 4122, baseband processing circuitry 4124, and application processing circuitry 4126. In other embodiments, the processing circuitry may comprise different components and/or different combinations of components. In certain embodiments processing circuitry 4120 of WD 4110 may comprise a SOC. In some embodiments, RF transceiver circuitry 4122, baseband processing circuitry 4124, and application processing circuitry 4126 may be on separate chips or sets of chips. In alternative embodiments, part or all of baseband processing circuitry 4124 and application processing circuitry 4126 may be combined into one chip or set of chips, and RF transceiver circuitry 4122 may be on a separate chip or set of chips. In still alternative embodiments, part or all of RF transceiver circuitry 4122 and baseband processing circuitry 4124 may be on the same chip or set of chips, and application processing circuitry 4126 may be on a separate chip or set of chips. In yet other alternative embodiments, part or all of RF transceiver circuitry 4122, baseband processing circuitry 4124, and application processing circuitry 4126 may be combined in the same chip or set of chips. In some embodiments, RF transceiver circuitry 4122 may be a part of interface 4114. RF transceiver circuitry 4122 may condition RF signals for processing circuitry 4120.

In certain embodiments, some or all of the functionality described herein as being performed by a WD may be provided by processing circuitry 4120 executing instructions stored on device readable medium 4130, which in certain embodiments may be a computer-readable storage medium. In alternative embodiments, some or all of the functionality may be provided by processing circuitry 4120 without executing instructions stored on a separate or discrete device readable storage medium, such as in a hard-wired manner. In any of those particular embodiments, whether executing instructions stored on a device readable storage medium or not, processing circuitry 4120 can be configured to perform the described functionality. The benefits provided by such functionality are not limited to processing circuitry 4120 alone or to other components of WD 4110, but are enjoyed by WD 4110 as a whole, and/or by end users and the wireless network generally.

Processing circuitry 4120 may be configured to perform any determining, calculating, or similar operations (e.g., certain obtaining operations) described herein as being performed by a WD. These operations, as performed by processing circuitry 4120, may include processing information obtained by processing circuitry 4120 by, for example, converting the obtained information into other information, comparing the obtained information or converted information to information stored by WD 4110, and/or performing one or more operations based on the obtained information or converted information, and as a result of said processing making a determination.

Device readable medium 4130 may be operable to store a computer program, software, an application including one or more of logic, rules, code, tables, etc. and/or other instructions capable of being executed by processing circuitry 4120. Device readable medium 4130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4120. In some embodiments, processing circuitry 4120 and device readable medium 4130 may be considered to be integrated.

User interface equipment 4132 may provide components that allow for a human user to interact with WD 4110. Such interaction may be of many forms, such as visual, audial, tactile, etc. User interface equipment 4132 may be operable to produce output to the user and to allow the user to provide input to WD 4110. The type of interaction may vary depending on the type of user interface equipment 4132 installed in WD 4110. For example, if WD 4110 is a smart phone, the interaction may be via a touch screen; if WD 4110 is a smart meter, the interaction may be through a screen that provides usage (e.g., the number of gallons used) or a speaker that provides an audible alert (e.g., if smoke is detected). User interface equipment 4132 may include input interfaces, devices and circuits, and output interfaces, devices and circuits. User interface equipment 4132 is configured to allow input of information into WD 4110, and is connected to processing circuitry 4120 to allow processing circuitry 4120 to process the input information. User interface equipment 4132 may include, for example, a microphone, a proximity or other sensor, keys/buttons, a touch display, one or more cameras, a USB port, or other input circuitry. User interface equipment 4132 is also configured to allow output of information from WD 4110, and to allow processing circuitry 4120 to output information from WD 4110. User interface equipment 4132 may include, for example, a speaker, a display, vibrating circuitry, a USB port, a headphone interface, or other output circuitry. Using one or more input and output interfaces, devices, and circuits, of user interface equipment 4132, WD 4110 may communicate with end users and/or the wireless network, and allow them to benefit from the functionality described herein.

Auxiliary equipment 4134 is operable to provide more specific functionality which may not be generally performed by WDs. This may comprise specialized sensors for doing measurements for various purposes, interfaces for additional types of communication such as wired communications etc. The inclusion and type of components of auxiliary equipment 4134 may vary depending on the embodiment and/or scenario.

Power source 4136 may, in some embodiments, be in the form of a battery or battery pack. Other types of power sources, such as an external power source (e.g., an electricity outlet), photovoltaic devices or power cells, may also be used. WD 4110 may further comprise power circuitry 4137 for delivering power from power source 4136 to the various parts of WD 4110 which need power from power source 4136 to carry out any functionality described or indicated herein. Power circuitry 4137 may in certain embodiments comprise power management circuitry. Power circuitry 4137 may additionally or alternatively be operable to receive power from an external power source; in which case WD 4110 may be connectable to the external power source (such as an electricity outlet) via input circuitry or an interface such as an electrical power cable. Power circuitry 4137 may also in certain embodiments be operable to deliver power from an external power source to power source 4136. This may be, for example, for the charging of power source 4136. Power circuitry 4137 may perform any formatting, converting, or other modification to the power from power source 4136 to make the power suitable for the respective components of WD 4110 to which power is supplied.

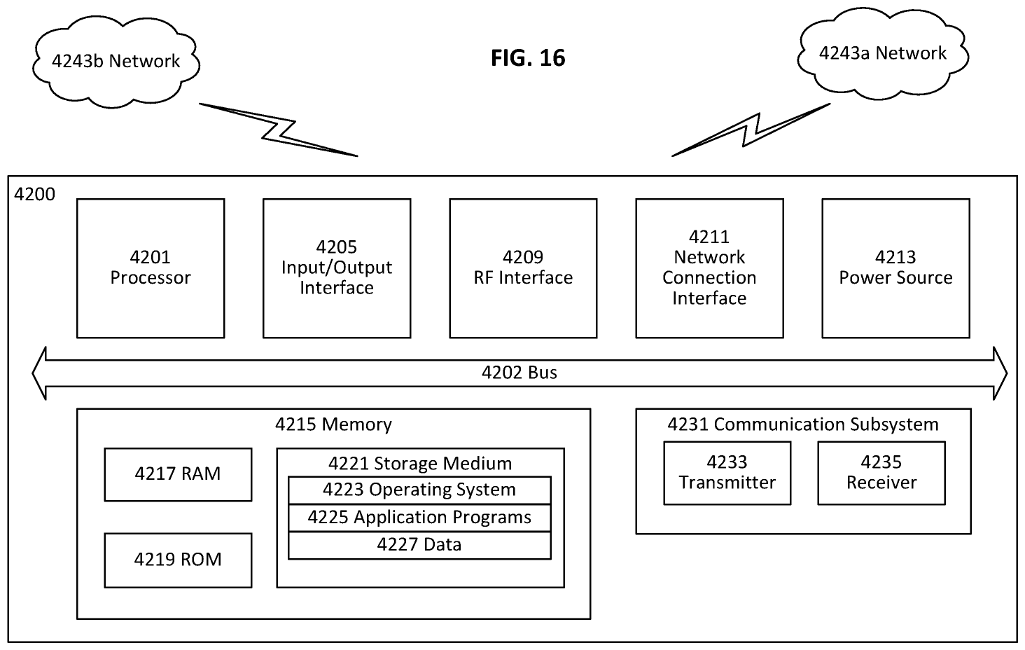

FIG. 16 illustrates a user Equipment in accordance with some embodiments.

FIG. 16 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 42200 may be any UE identified by the 3rd Generation Partnership Project (3GPP), including a NB-IOT UE, a machine type communication (MTC) UE, and/or an enhanced MTC (eMTC) UE. UE 4200, as illustrated in FIG. 16, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 16 is a UE, the components discussed herein are equally applicable to a WD, and vice-versa.

In FIG. 16, UE 4200 includes processing circuitry 4201 that is operatively coupled to input/output interface 4205, radio frequency (RF) interface 4209, network connection interface 4211, memory 4215 including random access memory (RAM) 4217, read-only memory (ROM) 4219, and storage medium 4221 or the like, communication subsystem 4231, power source 4213, and/or any other component, or any combination thereof. Storage medium 4221 includes operating system 4223, application program 4225, and data 4227. In other embodiments, storage medium 4221 may include other similar types of information. Certain UEs may utilize all of the components shown in FIG. 16, or only a subset of the components. The level of integration between the components may vary from one UE to another UE. Further, certain UEs may contain multiple instances of a component, such as multiple processors, memories, transceivers, transmitters, receivers, etc.

In FIG. 16, processing circuitry 4201 may be configured to process computer instructions and data. Processing circuitry 4201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 4201 may include two central processing units (CPUs). Data may be information in a form suitable for use by a computer.

In the depicted embodiment, input/output interface 4205 may be configured to provide a communication interface to an input device, output device, or input and output device. UE 4200 may be configured to use an output device via input/output interface 4205. An output device may use the same type of interface port as an input device. For example, a USB port may be used to provide input to and output from UE 4200. The output device may be a speaker, a sound card, a video card, a display, a monitor, a printer, an actuator, an emitter, a smartcard, another output device, or any combination thereof. UE 4200 may be configured to use an input device via input/output interface 4205 to allow a user to capture information into UE 4200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 16, RF interface 4209 may be configured to provide a communication interface to RF components such as a transmitter, a receiver, and an antenna. Network connection interface 4211 may be configured to provide a communication interface to network 4243a. Network 4243a may encompass wired and/or wireless networks such as a local-area network (LAN), a wide-area network (WAN), a computer network, a wireless network, a telecommunications network, another like network or any combination thereof. For example, network 4243a may comprise a Wi-Fi network. Network connection interface 4211 may be configured to include a receiver and a transmitter interface used to communicate with one or more other devices over a communication network according to one or more communication protocols, such as Ethernet, TCP/IP, SONET, ATM, or the like. Network connection interface 4211 may implement receiver and transmitter functionality appropriate to the communication network links (e.g., optical, electrical, and the like). The transmitter and receiver functions may share circuit components, software or firmware, or alternatively may be implemented separately.

RAM 4217 may be configured to interface via bus 4202 to processing circuitry 4201 to provide storage or caching of data or computer instructions during the execution of software programs such as the operating system, application programs, and device drivers. ROM 4219 may be configured to provide computer instructions or data to processing circuitry 4201. For example, ROM 4219 may be configured to store invariant low-level system code or data for basic system functions such as basic input and output (I/O), startup, or reception of keystrokes from a keyboard that are stored in a non-volatile memory. Storage medium 4221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 4221 may be configured to include operating system 4223, application program 4225 such as a web browser application, a widget or gadget engine or another application, and data file 4227. Storage medium 4221 may store, for use by UE 4200, any of a variety of various operating systems or combinations of operating systems.

Storage medium 4221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 4221 may allow UE 4200 to access computer-executable instructions, application programs or the like, stored on transitory or non-transitory memory media, to off-load data, or to upload data. An article of manufacture, such as one utilizing a communication system may be tangibly embodied in storage medium 4221, which may comprise a device readable medium.

In FIG. 16, processing circuitry 4201 may be configured to communicate with network 4243b using communication subsystem 4231. Network 4243a and network 4243b may be the same network or networks or different network or networks. Communication subsystem 4231 may be configured to include one or more transceivers used to communicate with network 4243b. For example, communication subsystem 4231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 4233 and/or receiver 4235 to implement transmitter or receiver functionality, respectively, appropriate to the RAN links (e.g., frequency allocations and the like). Further, transmitter 4233 and receiver 4235 of each transceiver may share circuit components, software or firmware, or alternatively may be implemented separately.

In the illustrated embodiment, the communication functions of communication subsystem 4231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 4231 may include cellular communication, Wi-Fi communication, Bluetooth communication, and GPS communication. Network 4243b may encompass wired and/or wireless networks such as a local-area network (LAN), a wide-area network (WAN), a computer network, a wireless network, a telecommunications network, another like network or any combination thereof. For example, network 4243b may be a cellular network, a Wi-Fi network, and/or a near-field network. Power source 4213 may be configured to provide alternating current (AC) or direct current (DC) power to components of UE 4200.

The features, benefits and/or functions described herein may be implemented in one of the components of UE 4200 or partitioned across multiple components of UE 4200. Further, the features, benefits, and/or functions described herein may be implemented in any combination of hardware, software or firmware. In one example, communication subsystem 4231 may be configured to include any of the components described herein. Further, processing circuitry 4201 may be configured to communicate with any of such components over bus 4202. In another example, any of such components may be represented by program instructions stored in memory that when executed by processing circuitry 4201 perform the corresponding functions described herein. In another example, the functionality of any of such components may be partitioned between processing circuitry 4201 and communication subsystem 4231. In another example, the non-computationally intensive functions of any of such components may be implemented in software or firmware and the computationally intensive functions may be implemented in hardware.

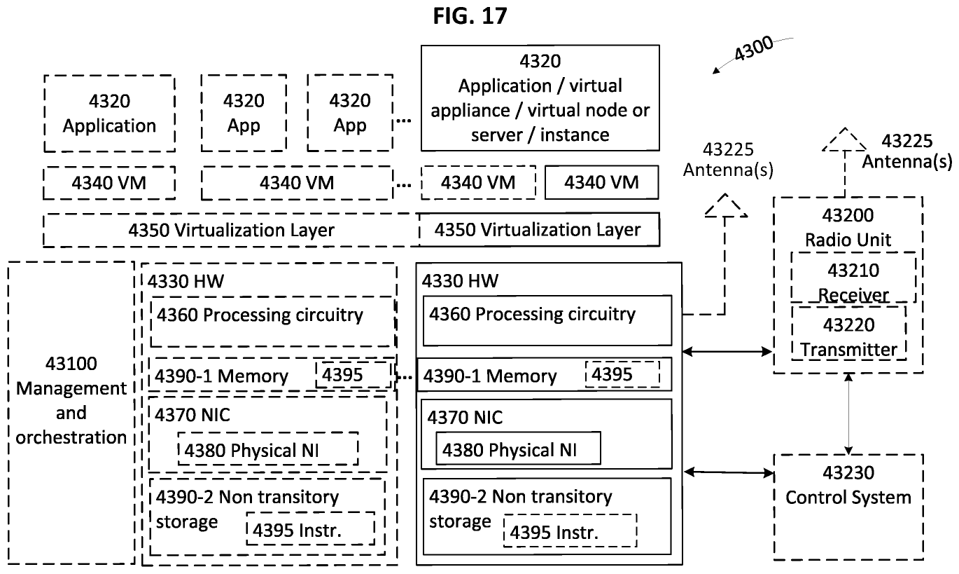

FIG. 17 illustrates a virtualization environment in accordance with some embodiments.

FIG. 17 is a schematic block diagram illustrating a virtualization environment 4300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 4300 hosted by one or more of hardware nodes 4330. Further, in embodiments in which the virtual node is not a radio access node or does not require radio connectivity (e.g., a core network node), then the network node may be entirely virtualized.

The functions may be implemented by one or more applications 4320 (which may alternatively be called software instances, virtual appliances, network functions, virtual nodes, virtual network functions, etc.) operative to implement some of the features, functions, and/or benefits of some of the embodiments disclosed herein. Applications 4320 are run in virtualization environment 4300 which provides hardware 4330 comprising processing circuitry 4360 and memory 4390. Memory 4390 contains instructions 4395 executable by processing circuitry 4360 whereby application 4320 is operative to provide one or more of the features, benefits, and/or functions disclosed herein.

Virtualization environment 4300, comprises general-purpose or special-purpose network hardware devices 4330 comprising a set of one or more processors or processing circuitry 4360, which may be commercial off-the-shelf (COTS) processors, dedicated Application Specific Integrated Circuits (ASICs), or any other type of processing circuitry including digital or analog hardware components or special purpose processors. Each hardware device may comprise memory 4390-1 which may be non-persistent memory for temporarily storing instructions 4395 or software executed by processing circuitry 4360. Each hardware device may comprise one or more network interface controllers (NICs) 4370, also known as network interface cards, which include physical network interface 4380. Each hardware device may also include non-transitory, persistent, machine-readable storage media 4390-2 having stored therein software 4395 and/or instructions executable by processing circuitry 4360. Software 4395 may include any type of software including software for instantiating one or more virtualization layers 4350 (also referred to as hypervisors), software to execute virtual machines 4340 as well as software allowing it to execute functions, features and/or benefits described in relation with some embodiments described herein.

Virtual machines 4340 comprise virtual processing, virtual memory, virtual networking or interface and virtual storage, and may be run by a corresponding virtualization layer 4350 or hypervisor. Different embodiments of the instance of virtual appliance 4320 may be implemented on one or more of virtual machines 4340, and the implementations may be made in different ways.

During operation, processing circuitry 4360 executes software 4395 to instantiate the hypervisor or virtualization layer 4350, which may sometimes be referred to as a virtual machine monitor (VMM). Virtualization layer 4350 may present a virtual operating platform that appears like networking hardware to virtual machine 4340.

As shown in FIG. 17, hardware 4330 may be a standalone network node with generic or specific components. Hardware 4330 may comprise antenna 43225 and may implement some functions via virtualization. Alternatively, hardware 4330 may be part of a larger cluster of hardware (e.g. such as in a data center or customer premise equipment (CPE)) where many hardware nodes work together and are managed via management and orchestration (MANO) 43100, which, among others, oversees lifecycle management of applications 4320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 4340 may be a software implementation of a physical machine that runs programs as if they were executing on a physical, non-virtualized machine. Each of virtual machines 4340, and that part of hardware 4330 that executes that virtual machine, be it hardware dedicated to that virtual machine and/or hardware shared by that virtual machine with others of the virtual machines 4340, forms a separate virtual network elements (VNE).

Still in the context of NFV, Virtual Network Function (VNF) is responsible for handling specific network functions that run in one or more virtual machines 4340 on top of hardware networking infrastructure 4330 and corresponds to application 4320 in FIG. 17.

In some embodiments, one or more radio units 43200 that each include one or more transmitters 43220 and one or more receivers 43210 may be coupled to one or more antennas 43225. Radio units 43200 may communicate directly with hardware nodes 4330 via one or more appropriate network interfaces and may be used in combination with the virtual components to provide a virtual node with radio capabilities, such as a radio access node or a base station.

In some embodiments, some signalling can be effected with the use of control system 43230 which may alternatively be used for communication between the hardware nodes 4330 and radio units 43200.

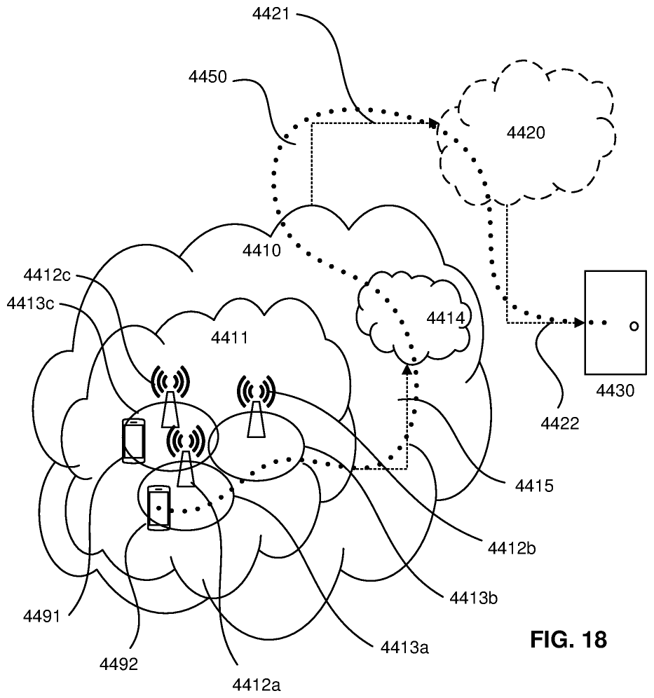

FIG. 18 illustrates a telecommunication network connected via an intermediate network to a host computer in accordance with some embodiments.

With reference to FIG. 18, in accordance with an embodiment, a communication system includes telecommunication network 4410, such as a 3GPP-type cellular network, which comprises access network 4411, such as a radio access network, and core network 4414. Access network 4411 comprises a plurality of base stations 4412a, 4412b, 4412c, such as NBs, eNBs, gNBs or other types of wireless access points, each defining a corresponding coverage area 4413a, 4413b, 4413c. Each base station 4412a, 4412b, 4412c is connectable to core network 4414 over a wired or wireless connection 4415. A first UE 4491 located in coverage area 4413c is configured to wirelessly connect to, or be paged by, the corresponding base station 4412c. A second UE 4492 in coverage area 4413a is wirelessly connectable to the corresponding base station 4412a. While a plurality of UEs 4491, 4492 are illustrated in this example, the disclosed embodiments are equally applicable to a situation where a sole UE is in the coverage area or where a sole UE is connecting to the corresponding base station 4412.

Telecommunication network 4410 is itself connected to host computer 4430, which may be embodied in the hardware and/or software of a standalone server, a cloud-implemented server, a distributed server or as processing resources in a server farm. Host computer 4430 may be under the ownership or control of a service provider, or may be operated by the service provider or on behalf of the service provider. Connections 4421 and 4422 between telecommunication network 4410 and host computer 4430 may extend directly from core network 4414 to host computer 4430 or may go via an optional intermediate network 4420. Intermediate network 4420 may be one of, or a combination of more than one of, a public, private or hosted network; intermediate network 4420, if any, may be a backbone network or the Internet; in particular, intermediate network 4420 may comprise two or more sub-networks (not shown).

The communication system of FIG. 18 as a whole enables connectivity between the connected UEs 4491, 4492 and host computer 4430. The connectivity may be described as an over-the-top (OTT) connection 4450. Host computer 4430 and the connected UEs 4491, 4492 are configured to communicate data and/or signaling via OTT connection 4450, using access network 4411, core network 4414, any intermediate network 4420 and possible further infrastructure (not shown) as intermediaries. OTT connection 4450 may be transparent in the sense that the participating communication devices through which OTT connection 4450 passes are unaware of routing of uplink and downlink communications. For example, base station 4412 may not or need not be informed about the past routing of an incoming downlink communication with data originating from host computer 4430 to be forwarded (e.g., handed over) to a connected UE 4491. Similarly, base station 4412 need not be aware of the future routing of an outgoing uplink communication originating from the UE 4491 towards the host computer 4430.

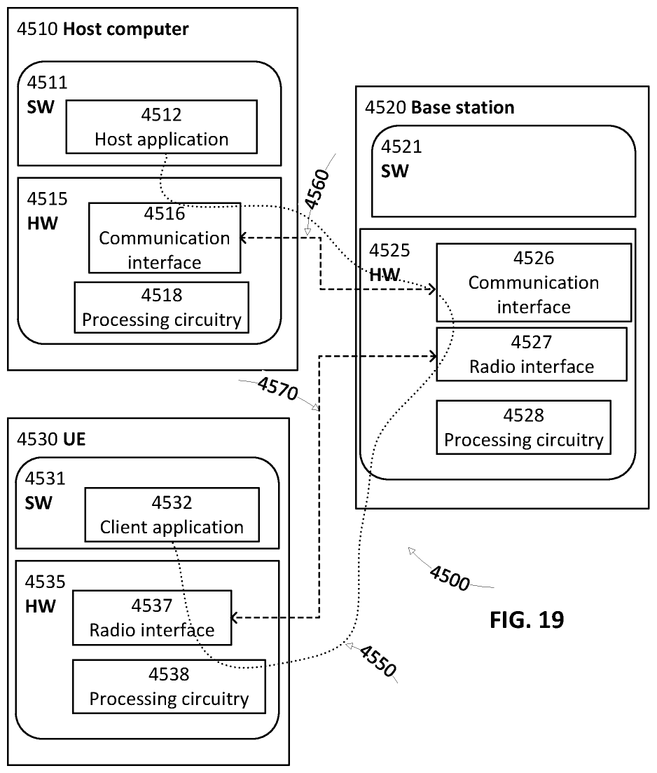

FIG. 19 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 19. In communication system 4500, host computer 4510 comprises hardware 4515 including communication interface 4516 configured to set up and maintain a wired or wireless connection with an interface of a different communication device of communication system 4500. Host computer 4510 further comprises processing circuitry 4518, which may have storage and/or processing capabilities. In particular, processing circuitry 4518 may comprise one or more programmable processors, application-specific integrated circuits, field programmable gate arrays or combinations of these (not shown) adapted to execute instructions. Host computer 4510 further comprises software 4511, which is stored in or accessible by host computer 4510 and executable by processing circuitry 4518. Software 4511 includes host application 4512. Host application 4512 may be operable to provide a service to a remote user, such as UE 4530 connecting via OTT connection 4550 terminating at UE 4530 and host computer 4510. In providing the service to the remote user, host application 4512 may provide user data which is transmitted using OTT connection 4550.

Communication system 4500 further includes base station 4520 provided in a telecommunication system and comprising hardware 4525 enabling it to communicate with host computer 4510 and with UE 4530. Hardware 4525 may include communication interface 4526 for setting up and maintaining a wired or wireless connection with an interface of a different communication device of communication system 4500, as well as radio interface 4527 for setting up and maintaining at least wireless connection 4570 with UE 4530 located in a coverage area (not shown in FIG. 19) served by base station 4520. Communication interface 4526 may be configured to facilitate connection 4560 to host computer 4510. Connection 4560 may be direct or it may pass through a core network (not shown in FIG. 19) of the telecommunication system and/or through one or more intermediate networks outside the telecommunication system. In the embodiment shown, hardware 4525 of base station 4520 further includes processing circuitry 4528, which may comprise one or more programmable processors, application-specific integrated circuits, field programmable gate arrays or combinations of these (not shown) adapted to execute instructions. Base station 4520 further has software 4521 stored internally or accessible via an external connection.

Communication system 4500 further includes UE 4530 already referred to. Its hardware 4535 may include radio interface 4537 configured to set up and maintain wireless connection 4570 with a base station serving a coverage area in which UE 4530 is currently located. Hardware 4535 of UE 4530 further includes processing circuitry 4538, which may comprise one or more programmable processors, application-specific integrated circuits, field programmable gate arrays or combinations of these (not shown) adapted to execute instructions. UE 4530 further comprises software 4531, which is stored in or accessible by UE 4530 and executable by processing circuitry 4538. Software 4531 includes client application 4532. Client application 4532 may be operable to provide a service to a human or non-human user via UE 4530, with the support of host computer 4510. In host computer 4510, an executing host application 4512 may communicate with the executing client application 4532 via OTT connection 4550 terminating at UE 4530 and host computer 4510. In providing the service to the user, client application 4532 may receive request data from host application 4512 and provide user data in response to the request data. OTT connection 4550 may transfer both the request data and the user data. Client application 4532 may interact with the user to generate the user data that it provides.

It is noted that host computer 4510, base station 4520 and UE 4530 illustrated in FIG. 19 may be similar or identical to host computer 4430, one of base stations 4412a, 4412b, 4412c and one of UEs 4491, 4492 of FIG. 18, respectively. This is to say, the inner workings of these entities may be as shown in FIG. 19 and independently, the surrounding network topology may be that of FIG. 18.

In FIG. 19, OTT connection 4550 has been drawn abstractly to illustrate the communication between host computer 4510 and UE 4530 via base station 4520, without explicit reference to any intermediary devices and the precise routing of messages via these devices. Network infrastructure may determine the routing, which it may be configured to hide from UE 4530 or from the service provider operating host computer 4510, or both. While OTT connection 4550 is active, the network infrastructure may further take decisions by which it dynamically changes the routing (e.g., on the basis of load balancing consideration or reconfiguration of the network).

Wireless connection 4570 between UE 4530 and base station 4520 is in accordance with the teachings of the embodiments described throughout this disclosure. One or more of the various embodiments may improve the performance of OTT services provided to UE 4530 using OTT connection 4550, in which wireless connection 4570 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 4550 between host computer 4510 and UE 4530, in response to variations in the measurement results. The measurement procedure and/or the network functionality for reconfiguring OTT connection 4550 may be implemented in software 4511 and hardware 4515 of host computer 4510 or in software 4531 and hardware 4535 of UE 4530, or both. In embodiments, sensors (not shown) may be deployed in or in association with communication devices through which OTT connection 4550 passes; the sensors may participate in the measurement procedure by supplying values of the monitored quantities exemplified above, or supplying values of other physical quantities from which software 4511, 4531 may compute or estimate the monitored quantities. The reconfiguring of OTT connection 4550 may include message format, retransmission settings, preferred routing etc.; the reconfiguring need not affect base station 4520, and it may be unknown or imperceptible to base station 4520. Such procedures and functionalities may be known and practiced in the art. In certain embodiments, measurements may involve proprietary UE signaling facilitating host computer 4510's measurements of throughput, propagation times, latency and the like. The measurements may be implemented in that software 4511 and 4531 causes messages to be transmitted, in particular empty or ‘dummy’ messages, using OTT connection 4550 while it monitors propagation times, errors etc.

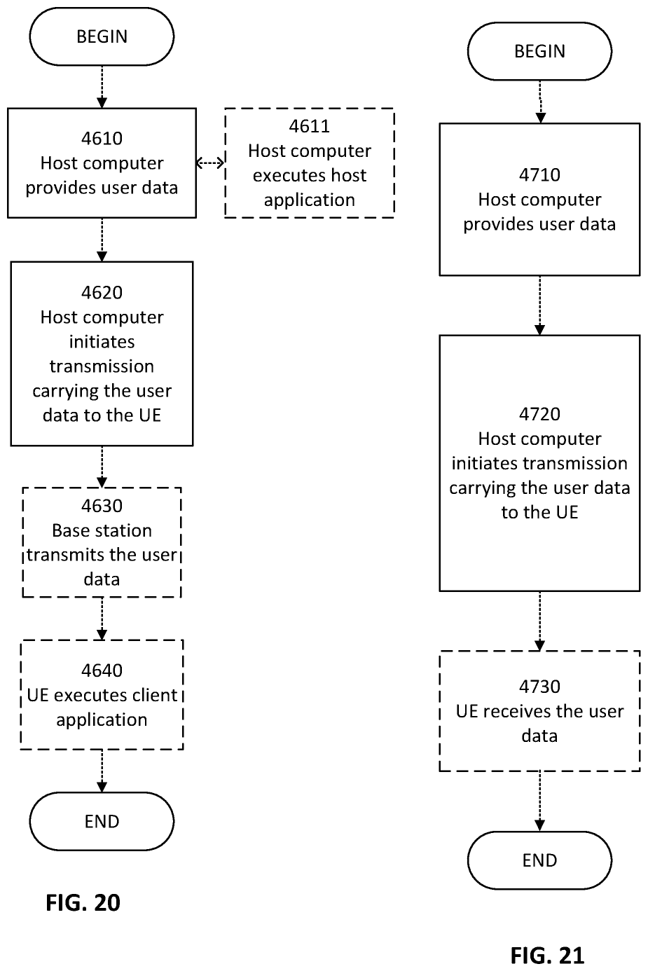

FIG. 20 illustrates methods implemented in a communication system including a host computer, a base station and a user equipment in accordance with some embodiments

FIG. 20 is a flowchart illustrating a method implemented in a communication system, in accordance with one embodiment. The communication system includes a host computer, a base station and a UE which may be those described with reference to FIGS. 18-19. For simplicity of the present disclosure, only drawing references to FIG. 20 will be included in this section. In step 4610, the host computer provides user data. In substep 4611 (which may be optional) of step 4610, the host computer provides the user data by executing a host application. In step 4620, the host computer initiates a transmission carrying the user data to the UE. In step 4630 (which may be optional), the base station transmits to the UE the user data which was carried in the transmission that the host computer initiated, in accordance with the teachings of the embodiments described throughout this disclosure. In step 4640 (which may also be optional), the UE executes a client application associated with the host application executed by the host computer.

FIG. 21 illustrates methods implemented in a communication system including a host computer, a base station and a user equipment in accordance with some embodiments.

FIG. 21 is a flowchart illustrating a method implemented in a communication system, in accordance with one embodiment. The communication system includes a host computer, a base station and a UE which may be those described with reference to FIGS. 18-19. For simplicity of the present disclosure, only drawing references to FIG. 21 will be included in this section. In step 4710 of the method, the host computer provides user data. In an optional substep (not shown) the host computer provides the user data by executing a host application. In step 4720, the host computer initiates a transmission carrying the user data to the UE. The transmission may pass via the base station, in accordance with the teachings of the embodiments described throughout this disclosure. In step 4730 (which may be optional), the UE receives the user data carried in the transmission.

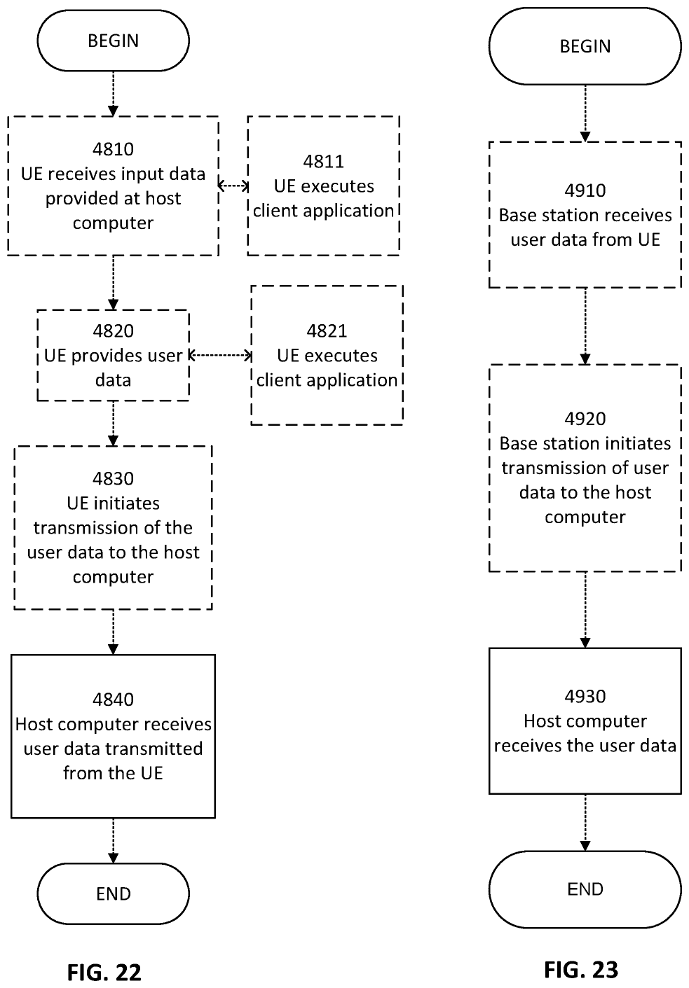

FIG. 22 illustrates methods implemented in a communication system including a host computer, a base station and a user equipment in accordance with some embodiments

FIG. 22 is a flowchart illustrating a method implemented in a communication system, in accordance with one embodiment. The communication system includes a host computer, a base station and a UE which may be those described with reference to FIGS. 18-19. For simplicity of the present disclosure, only drawing references to FIG. 22 will be included in this section. In step 4810 (which may be optional), the UE receives input data provided by the host computer. Additionally or alternatively, in step 4820, the UE provides user data. In substep 4821 (which may be optional) of step 4820, the UE provides the user data by executing a client application. In substep 4811 (which may be optional) of step 4810, the UE executes a client application which provides the user data in reaction to the received input data provided by the host computer. In providing the user data, the executed client application may further consider user input received from the user. Regardless of the specific manner in which the user data was provided, the UE initiates, in substep 4830 (which may be optional), transmission of the user data to the host computer. In step 4840 of the method, the host computer receives the user data transmitted from the UE, in accordance with the teachings of the embodiments described throughout this disclosure.

FIG. 23 illustrates methods implemented in a communication system including a host computer, a base station and a user equipment in accordance with some embodiments

FIG. 23 is a flowchart illustrating a method implemented in a communication system, in accordance with one embodiment. The communication system includes a host computer, a base station and a UE which may be those described with reference to FIGS. 18-19. For simplicity of the present disclosure, only drawing references to FIG. 23 will be included in this section. In step 4910 (which may be optional), in accordance with the teachings of the embodiments described throughout this disclosure, the base station receives user data from the UE. In step 4920 (which may be optional), the base station initiates transmission of the received user data to the host computer. In step 4930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of operating a communication device in a communications network that includes a network node, the method comprising:
obtaining a plurality of channel state information, CSI, reporting configurations;
determining a link quality measurement using CSI resources associated with the plurality of CSI reporting configurations;
responsive to determining the link quality measurement, determining a CSI reporting configuration to be used in communicating CSI with the network node from the plurality of CSI reporting configurations based on the link quality measurement; and
responsive to determining the CSI reporting configuration, transmitting information associated with the CSI reporting configuration to the network node.

2. The method of claim 1, wherein the plurality of CSI reporting configurations comprises at least one of:
a wide-band CSI reporting configuration;
a sub-band CSI reporting configuration;
a statistical CSI reporting configuration; and
a hybrid automatic repeat request, HARQ, based CSI reporting configuration.

3. The method of claim 1, wherein obtaining the plurality of CSI reporting configurations comprises:
receiving at least a portion of the plurality of CSI reporting configurations from the network node.

4. The method of claim 1, wherein transmitting the information comprises:
transmitting an indicator of the CSI reporting configuration to the network node.

5. The method of claim 1, wherein transmitting the information comprises:
transmitting a CSI report to the network node based on the CSI reporting configuration.

6. The method of claim 5, wherein transmitting the information further comprises:
receiving a request from the network node for the CSI report; and
transmitting the CSI report in response to receiving the request; or
wherein transmitting the information further comprises:
determining that the link quality measurement exceeds a threshold value; and
transmitting the CSI report in response to determining that the link quality measurement exceeds the threshold value; or
wherein transmitting the information further comprises:
detecting occurrence of an event; and
transmitting the CSI report in response to detecting occurrence of the event, the event comprising at least one of:
a beam change;
a precoder change;
receiving a scheduling command with multi-transmission/reception point, TRP, allocation;
radio resource control, RRC, reconfiguration;
a handover, a data decoding failure; and
a timer based event.

7.-9. (canceled)

10. The method of claim 1, wherein determining the link quality measurement comprises:
measuring the link quality measurement associated with a reference signal including at least one of:
a channel state information reference signal, CSI-RS;
a channel state information interference measurement, CSI-IM;
a demodulation reference signal, DMRS;
a phase tracking reference signal, PTRS; a tracking reference signal, TRS; and
a synchronization signal block, SSB.

11. The method of claim 1, wherein determining the link quality measurement comprises:
determining the link quality measurement based on decoder output,
wherein the decoder output comprises at least one of:
an indication of a number of iterations that were needed during a decoding procedure;
an indication of a number of soft value changes during the decoding procedure;
an indication of a number of bits that were flipped during the decoding procedure; and
an indication of a decoding margin during the decoding procedure.

12. The method of claim 1, wherein the communications network is a new radio, NR, network, and wherein the network node is a radio access network, RAN, node.

13. The method of claim 1, further comprising:
transmitting a first message to the network node, the first message indicating that the communication device is capable of determining the CSI reporting configuration; and
receiving a second message from the network node, the second message instructing the communication device to handle determination of the CSI reporting configuration from the plurality of CSI configurations.

14. (canceled)

15. (canceled)

16. A method of operating a network node in a communications network, the method comprising:
transmitting a plurality of channel state information, CSI, reporting configurations to a communication device; and
receiving information associated with a CSI reporting configuration of the plurality of CSI reporting configurations from the communication device.

17. The method of claim 16, wherein the plurality of CSI reporting configurations comprises at least one of:
a wide-band CSI reporting configuration;
a sub-band CSI reporting configuration;
a statistical CSI reporting configuration; and
a hybrid automatic repeat request, HARQ, based CSI reporting configuration.

18. The method of claim 16, wherein receiving the information comprises:
receiving an indicator of the CSI reporting configuration from the communication device.

19. The method of claim 16, wherein receiving the information comprises:
receiving a CSI report from the communication device based on the CSI reporting configuration.

20. The method of claim 19, wherein receiving the information further comprises:
transmitting a request for the CSI report to the communication device; and
receiving the CSI report in response to transmitting the request.

21. The method of claim 16, wherein the communications network is a new radio, NR, network, and wherein the network node is a radio access network, RAN, node.

22. The method of claim 16, further comprising:
receiving a first message from the communication device, the first message indicating that the communication device is capable of determining the CSI reporting configuration; and
transmitting a second message to the communication device, the second message instructing the communication device to handle determination of the CSI reporting configuration from the plurality of CSI configurations.

23. (canceled)

24. (canceled)

25. A communication device in a communications network that includes a network node, the communication device comprising:
processing circuitry; and
memory coupled to the processing circuitry and having instructions stored therein that are executable by the processing circuitry to cause the communication device to perform operations comprising:
obtaining a plurality of channel state information, CSI, reporting configurations;
determining a link quality measurement using CSI resources associated with the plurality of CSI reporting configurations;
responsive to determining the link quality measurement, determining a CSI reporting configuration to be used in communicating CSI with the network node from the plurality of CSI reporting configurations based on the link quality measurement; and
responsive to determining the CSI reporting configuration, transmitting information associated with the CSI reporting configuration to the network node.

26. (canceled)

27. (canceled)

28. A computer program product comprising a non-transitory storage medium including program code to be executed by processing circuitry of a communication device in a communications network that includes a network node, whereby execution of the program code causes the communication device to:
obtain a plurality of channel state information, CSI, reporting configurations;
determine a link quality measurement using CSI resources associated with the plurality of CSI reporting configurations;
responsive to determining the link quality measurement, determine a CSI reporting configuration to be used in communicating CSI with the network node from the plurality of CSI reporting configurations based on the link quality measurement; and
responsive to determining the CSI reporting configuration, transmit information associated with the CSI reporting configuration to the network node.

29. A network node in a communications network, the network node comprising:
processing circuitry; and
memory coupled to the processing circuitry and having instructions stored therein that are executable by the processing circuitry to cause the network node to:
transmit a plurality of channel state information, CSI, reporting configurations to a communication device; and
receive information associated with a CSI reporting configuration of the plurality of CSI reporting configurations from the communication device.

30.-32. (canceled)
